(19) United States
(12) Patent Application Publication
(10) Pub. No.: US 2026/0260583 A1
(43) Pub. Date: Sep. 3, 2026

(54) SYSTEM AND METHOD FOR ANATOMIC SIMULACRA WITH EMBEDDED ELECTRONIC COMPONENTS

(71) Applicant: Arthrex, Inc., Naples, FL (US)

(72) Inventors: Nick Metcalfe, Bonita Springs, FL (US); David Knopf, Bonita Springs, FL (US)

(73) Assignee: Arthrex, Inc., Naples, FL (US)

(21) Appl. No.: 19/555,747

(22) Filed: Mar. 3, 2026

Related U.S. Application Data
(60) Provisional application No. 63/766,160, filed on Mar. 3, 2025.

(51) Int. Cl. G09B 23/30

(52) U.S. Cl. CPC G09B 23/30

(57) ABSTRACT

Anatomic simulacra is provided that includes a communication system, which is coupled to the anatomic simulacra. The communication system is to communicate data regarding the anatomic simulacra to an external device, such as a personal electronic device.

### CROSS-REFERENCE TO RELATED APPLICATION

This application priority to and the benefit of U.S. Provisional Application No. 63/766,160 filed on Mar. 3, 2025. The disclosure of the above application is incorporated herein by reference.

### BACKGROUND

The present disclosure relates to medical devices and methods for surgical training, and more particularly relates to a system and a method for surgical training using anatomic simulacra with embedded electronic components.

Generally, surgical procedures may be practiced using a cadaver specimen. Cadaver specimens, however, require refrigeration along with special handling and disposal. Cadaver specimens may also have inconsistent quality due to freezing and thawing cycles, and the bone density may vary. Further, the mounting of cadaver specimens to practice a surgical procedure may be limited due to the nature of the particular cadaver specimen. In addition, due to the nature of the cadaver specimens, characteristics regarding the cadaver specimens may not be readily known until the performance of the surgical training procedure.

### SUMMARY

This section provides a general summary of the disclosure and is not a comprehensive disclosure of its full scope or all of its features.

The present disclosure provides a system and a method for surgical training using a polymer-based synthetic specimen, anatomic model or anatomic simulacra with embedded electronic components. The anatomic simulacra enables one or more surgical procedures to be practiced for training purposes. The anatomic simulacra may be formed using additive manufacturing techniques, such as three-dimensional (3D) printing or may be cast.

According to various embodiments, provided is anatomic simulacra. The anatomic simulacra includes a communication system, which is coupled to the anatomic simulacra. The communication system is configured to communicate data regarding the anatomic simulacra to an external device.

The communication system is embedded within a portion of the anatomic simulacra. The anatomic simulacra further comprises a controller, which is configured to command the communication system to communicate the data based on receipt of a request. The anatomic simulacra includes at least one sensor coupled to the anatomic simulacra, and the at least one sensor is configured to observe a portion of the anatomic simulacra and to generate sensor signals based thereon. The controller is configured to receive the sensor signals, and to command the communication system to communicate the sensor signals to the external device. The anatomic simulacra further includes at least one emitter associated with the at least one sensor. The at least one emitter is selected from the group including a light emitting element, an audio emitter, a haptic emitter, and combinations thereof. The controller is configured to output one or more control signals to the at least one emitter based on the sensor signals. The anatomic simulacra is polymer-based and corresponds to at least a portion of a human or animal anatomy. At least a portion of the anatomic simulacra is additively manufactured. The anatomic simulacra includes a mounting portion, and the communication system is coupled to the mounting portion. The anatomic simulacra further includes an identification tag, and the communication system is coupled to the anatomic simulacra so as to be proximate the identification tag. The communication system comprises a scannable code. The communication system comprises a radio frequency identification tag. The external device is configured to display the data regarding the anatomic simulacra on a display associated with the external device.

Further provided is a system for surgical training, which includes a polymer-based anatomic simulacra that corresponds to a part of an anatomy. The system also includes a communication system coupled to the anatomic simulacra that is configured to communicate data regarding the anatomic simulacra to an external device.

The system includes the external device, and the external device is at least one of a personal electronic device, a computing device associated with a surgical system, a remote system and a robot. The communication system is embedded within a portion of the anatomic simulacra. The anatomic simulacra further includes a controller, which is configured to command the communication system to communicate the data based on receipt of a request. The anatomic simulacra further includes at least one sensor coupled to the anatomic simulacra, and the at least one sensor is configured to observe a portion of the anatomic simulacra and to generate sensor signals based thereon. The controller is configured to receive the sensor signals, and to command the communication system to communicate the sensor signals to the external device. The anatomic simulacra is polymer-based and corresponds to at least a portion of a human or animal anatomy. At least a portion of the anatomic simulacra is additively manufactured. The anatomic simulacra includes a mounting portion, and the communication system is coupled to the mounting portion. The anatomic simulacra includes an identification tag, and the communication system is coupled to the anatomic simulacra so as to be proximate the identification tag. The anatomic simulacra further includes at least one sensor coupled to the anatomic simulacra, and the at least one sensor is configured to observe a portion of the anatomic simulacra and to generate sensor signals based thereon. The anatomic simulacra includes at least one emitter associated with the at least one sensor. The at least one emitter is selected from the group including a light emitting element, an audio emitter, a haptic emitter, and combinations thereof. The anatomic simulacra further includes a controller, and the controller is configured to output one or more control signals to the at least one emitter based on the sensor signals. The controller is configured to store the sensor signals and the one or more control signals as usage data associated with the anatomic simulacra in a datastore. The external device is configured to display the data regarding the anatomic simulacra on a display associated with the external device.

Also provided is a method for surgical training. The method includes providing a polymer-based anatomic simulacra that corresponds to a part of an anatomy with a system coupled to the anatomic simulacra, and communicating, by a processor of a controller of the system, data regarding the anatomic simulacra to an external device.

The method includes receiving, by the processor, a request for data from the external device and the communicating is based on the request. The external device is at least one of a personal electronic device, a computing device associated with a surgical system, a remote system and a robot. The anatomic simulacra includes at least one sensor coupled to the anatomic simulacra configured to observe a portion of the anatomic simulacra and to generate sensor signals based on the observation, and the method includes communicating, by the processor, the sensor signals to the external device. The method includes displaying, on a display associated with the external device, the sensor signals and the data regarding the anatomic simulacra.

Further provided is a method for surgical training. The method includes providing a polymer-based anatomic simulacra that corresponds to a part of an anatomy with a system coupled to the anatomic simulacra. The system includes at least one sensor and at least one emitter. The method includes observing at least a portion of the anatomic simulacra by the at least one sensor and generating sensor signals based on the observation, and outputting, by a processor of a controller of the system, one or more control signals to the at least one emitter based on the sensor signals.

The method includes storing, by the processor, at least the sensor signals and the one or more control signals as usage data in a datastore, and communicating the usage data to an external device. The external device is at least one of a personal electronic device, a computing device associated with a surgical system, a remote system and a robot.

Further areas of applicability will become apparent from the description provided herein. It should be understood that the description and specific examples are intended for purposes of illustration and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1A is a schematic illustration of a surgical environment.

FIG. 1B is a schematic illustration of a surgical system.

FIG. 1C is a functional block diagram of an exemplary system for surgical training using an exemplary anatomic simulacra with an embedded electronic component or specimen system along with an exemplary personal electronic device.

FIG. 2 is a front view of the anatomic simulacra of FIG. 1C in accordance with the various teachings of the present disclosure.

FIG. 3 is a dataflow diagram illustrating a specimen control system associated with the anatomic simulacra of FIG. 1C, in accordance with various examples.

FIG. 4 is a flowchart illustrating a method performed by the specimen control system in accordance with the various teachings of the present disclosure.

FIG. 5 is a dataflow diagram illustrating a device control system associated with the personal electronic device of FIG. 1C, in accordance with the various teachings of the present disclosure.

FIG. 6 is a flowchart illustrating a method performed by the device control system in accordance with the various teachings of the present disclosure.

FIG. 7 is a functional block diagram of another exemplary system for surgical training using an exemplary anatomic simulacra with an embedded electronic component or specimen system along with an exemplary personal electronic device.

FIG. 8 is a front view of the anatomic simulacra of FIG. 7 in accordance with the various teachings of the present disclosure.

FIG. 9 is a dataflow diagram illustrating a specimen control system associated with the anatomic simulacra of FIG. 7, in accordance with various examples.

FIG. 10 is a flowchart illustrating a method performed by the specimen control system of FIG. 9 in accordance with the various teachings of the present disclosure.

FIG. 11 is a dataflow diagram illustrating a device control system associated with the personal electronic device of FIG. 7, in accordance with the various teachings of the present disclosure.

FIG. 12 is a flowchart illustrating a method performed by the device control system of FIG. 11 in accordance with the various teachings of the present disclosure.

FIG. 13 is a front view of an exemplary anatomic simulacra for use with a system for surgical training in accordance with the various teachings of the present disclosure.

FIG. 14 is a functional block diagram of the anatomic simulacra and the system of FIG. 13.

FIG. 15 is a dataflow diagram illustrating a specimen control system associated with the anatomic simulacra of FIG. 14, in accordance with the various teachings of the present disclosure.

FIG. 16 is a flowchart illustrating a method performed by the specimen control system of FIG. 15 in accordance with the various teachings of the present disclosure.

FIG. 17 is a front view of the anatomic simulacra of FIG. 13, in which one or more implants have been coupled to the anatomic simulacra during a surgical training procedure in accordance with the various teachings of the present disclosure.

The drawings described herein are for illustration purposes and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features. In addition, there is no intention to be bound by any expressed or implied theory presented in the preceding introduction, brief summary or the following detailed description.

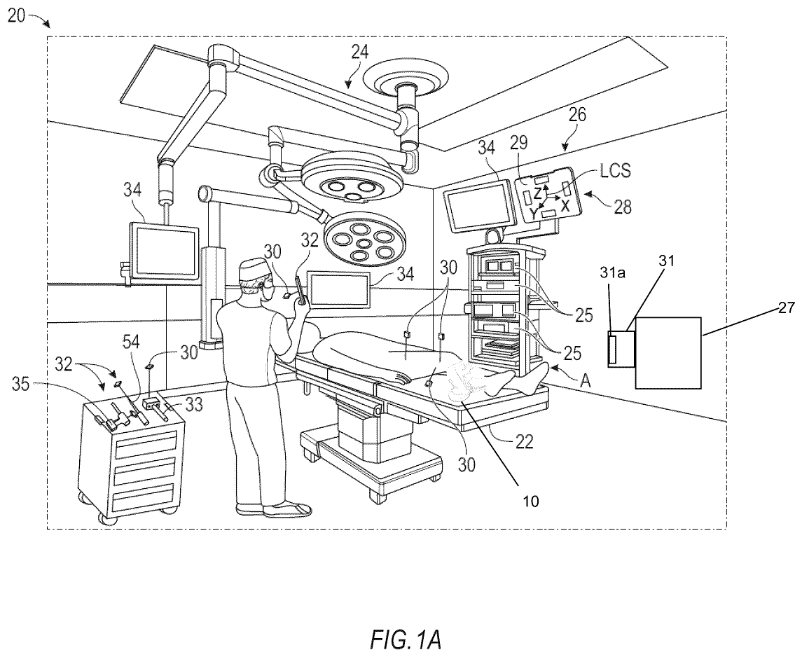

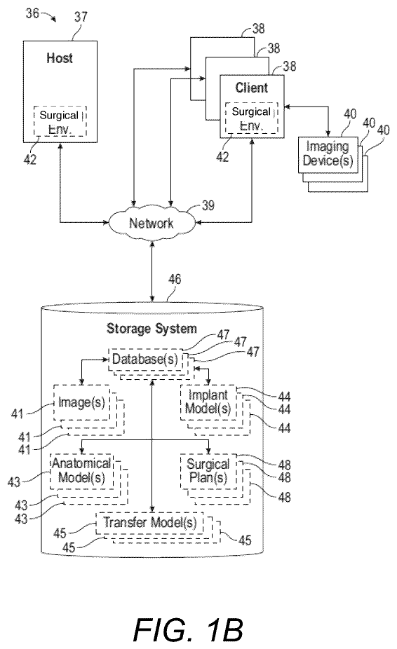

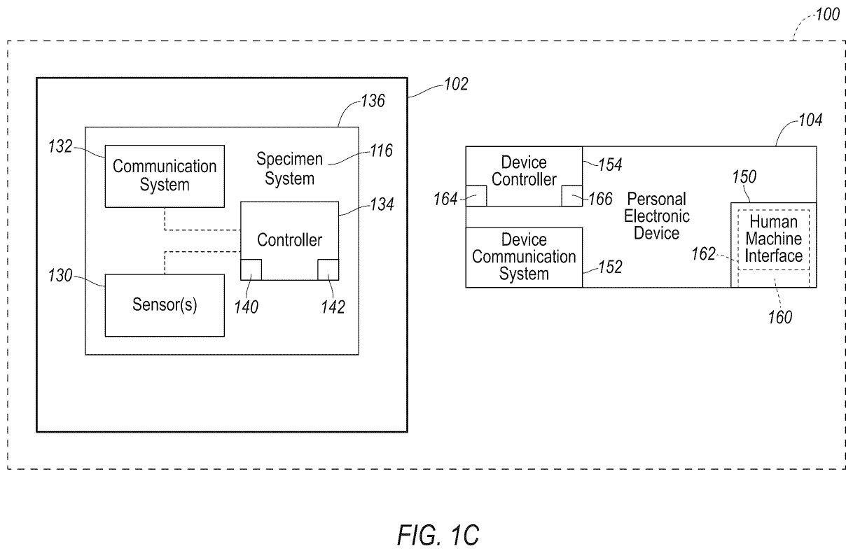

As described, the present disclosure provides a system and a method for surgical training using a polymer-based synthetic specimen, anatomic model or anatomic simulacra. The anatomic simulacra may be used in the place of a cadaveric specimen. The anatomic simulacra may be tailored to the anatomy of various patients, which enables a surgical trainee to practice a surgical procedure on different anatomical models. In addition, the anatomic simulacra may enable a predefined fracture pattern or repair procedure to be practiced, which may be difficult to practice otherwise. The system and the method may also enable data regarding the anatomic simulacra to be communicated to a personal electronic device associated with the trainee, which may provide the trainee with information regarding the anatomic simulacra. It should be noted that while the system and method are described herein as being used with a surgical training procedure that simulates a surgical procedure, it should be understood that the system and the method may also be used to practice a surgical technique, or a portion of a surgical procedure, and thus, the present disclosure is not limited to practicing a surgical procedure in its entirety. In addition, it should be noted that a “trainee” may comprise any suitable individual and/or a robot 27 (FIG. 1A), and the use of the term “trainee” is not intended to limit the scope of this disclosure.

FIG. 1A may provide a surgical suite (e.g., system or assembly) 20 according to an implementation. The surgical suite 20 may be utilized to perform various surgical procedures (e.g., manual surgical procedures, robotic-assisted surgical procedures, surgical training procedures), including but not limited to, an orthopedic procedure such as an arthroscopy or an arthroplasty to restore functionality to one or more bones and/or joints. The surgical procedure may include repair of one or more characteristics associated with a patient. For example, the surgical procedure may include repair of one or more bone pathologies (e.g., defects) associated with a bone of a patient. The surgical procedure may include repair of one or more soft tissues such as a damaged muscle, ligament, tendon or the like. The suite 20 may be utilized in the repair of various locations of the anatomy and other surgical procedures including repair of joints such as the shoulder, foot, ankle, wrist, hand, hip, knee, and spine. The suite 20 may also be used in a surgical training procedure to repair an anatomic simulacra 10. The anatomic simulacra 10 may comprise the anatomic simulacra 102, 402, 702, described below.

The suite 20 may include an operating table 22 for supporting an anatomy A of a patient and/or the anatomic simulacra 10, as will be described below. The suite 20 may include a light assembly 24, which may include one or more light sources for communicating light towards the patient anatomy A and/or the anatomic simulacra 10.

The suite 20 may include one or more computing devices 25. The computing device(s) 25 may include (e.g., processing) circuitry, including one or more processors coupled to memory, input devices, and/or output devices. The processor(s) may be collectively operable to perform any of the functionality disclosed herein. The computing device(s) 25 may be operable to establish a surgical plan and/or implement the surgical plan for treating the patient. The computing device(s) 25 may be operable to establish a surgical training procedure involving the anatomic simulacra 10.

The suite 20 may include an equipment tower 26. The equipment tower 26 may include one or more modules (e.g., systems), which may incorporate the computing device(s) 25. The module(s) may include a guidance (e.g., navigation or tracking) module 28. The guidance module 28 may include a localizer 29, which may be operatively coupled to the computing device(s) 25. The localizer 29 may include a sensor unit having one or more sensors. One or more trackers 30 may be situated (e.g., fixed or secured) relative to the patient anatomy A and/or the anatomic simulacra 10. The trackers 30 may comprise an anatomy tracker. The trackers 30 may include one or more objects (e.g., markers). The trackers 30 may include active devices (e.g., sensors or light emitting diodes) and/or passive devices (e.g., reflectors). The tracker(s) 30 may be placed relative to the anatomy A and/or the anatomic simulacra 10 and/or one or more surgical devices (e.g., instruments) 32. The devices 32 may include any of the devices disclosed herein. The devices 32 may include one or more surgical guides 33, cutting instruments 35, and/or surgical probes 54. The tracker(s) 30 may be placed relative to one or more landmarks of the anatomy A, and/or the anatomic simulacra 10. The surgeon or clinical user may manipulate the surgical devices 32 during a surgical procedure. The localizer 29 may be operable to determine (e.g., track) the position and/or orientation of the trackers 30. The guidance module 28 may be operable to determine the position and/or orientation of each tracker 30 with respect to a (e.g., localizer or global) coordinate system (e.g., framework) LCS of the localizer 29. The suite 20 may be operable to transfer coordinates in the coordinate system LCS to another coordinate system (e.g., framework), such as a local coordinate system of a surgical device 32 or a coordinate system associated with a surgical planning system, and/or vice versa, using various transformation techniques.

The suite 20 may include one or more displays 34. The computing device(s) 25 may be operable to cause the display(s) 34 to display various data and/or information associated with a patient and/or the anatomic simulacra 10, including a surgical plan and/or guidance information. A surgeon or clinical user may interact with the display(s) 34. The guidance module 28 may be operable to cause the display(s) 34 to display a position and/or orientation of the tracker(s) 30 and/or associated surgical device(s) 32 relative to the anatomy A of the patient and/or the anatomic simulacra 10.

The suite 20 may include the robot 27, which may be in communication with the computing devices 25. The computing devices 25 may be operable to control the robot 27. In some examples, the computing devices 25 may cause the robot 27 to perform a portion or all of a surgical procedure or surgical training procedure. In some examples, the computing devices 25 may be used to control the robot 27 to evaluate one or more characteristics of the patient and/or target anatomy. In other examples, the computing devices 25 may be operable to validate a movement of the robot 27 relative to the anatomic simulacra 10.

The robot 27 may be used to assist with and/or perform a surgical procedure, a training procedure, or both. In some examples, the robot 27 may be a hand-held robot. In some other examples, the robot 27 may include a robotic arm 31. The robot 27 may include a base and an end effector 31a operatively coupled with the base. The robot 27 may include one or more actuators to move the end effector 31a, the base, or both. The end effector 31a may comprise a working end of the robot 27, and may include a proximal portion to be operatively coupled to the base, and a distal portion that includes a surgical instrument or tool. The distal portion of the end effector 31a may include, but is not limited to, a burr, a drill, a probe, a saw, a medical device, a measuring device, one or more sensors, a microscope, a camera, a light, an endoscope, an ultrasound probe, an irrigation device, a suction device, a radiotherapy device, and/or any other instrument or tool useful for surgery, surgical planning, and/or surgical navigation. In one example, the anatomic simulacra 10 may be used to validate or verify an accuracy of a movement of the robotic arm 31 prior to the performance of the surgical procedure. The robot 27 may include a display.

FIG. 1B may provide a surgical (e.g., planning or guidance) system (e.g., assembly) 36 according to an implementation. The surgical suite 20 may incorporate and/or may interface with the surgical system 36. The surgical system 36 may be utilized for planning and/or executing orthopedic and/or other surgical procedures, including pre-operatively, intra-operatively and/or post-operatively to create, edit, execute and/or review surgical plans. The surgical system 36 may be utilized for various orthopedic and other surgical procedures, including any of the procedures disclosed herein. The surgical system 36 may be utilized in the design and/or placement of various surgical constructs (e.g., devices). Surgical constructs may include any item assembled and/or placed in the patient anatomy A and/or the anatomic simulacra 10 during surgery to repair, place and/or support tissue. Surgical constructs may include grafts and implants such as an implant incorporated into a prosthesis and/or surgical instruments such as a transfer guide for positioning one or more surgical instruments, implants and/or grafts. The grafts may include synthetic and/or biological materials, such as an allograft or autograft. The systems and methods disclosed herein may be utilized in the repair of various locations of the anatomy and various surgical procedures including repair of bones and joints associated with the anatomy A and/or the anatomic simulacra 10 such as the shoulder, foot, ankle, wrist, hand, hip, knee and spine. The surgical system 36 may be utilized to perform other orthopedic procedures, including sports medicine procedures which may be performed to repair and/or reconstruct ligament(s) and/or tendon(s) and which may include use of graft(s). Sports medicine procedures may include a rotator cuff repair and anterior cruciate ligament (ACL) and/or posterior cruciate ligament (PCL) repairs.

The surgical system 36 may include a host computer 37 and one or more client computers 38. The host computer 37 may be configured to execute one or more software programs. In implementations, the host computer 37 may be more than one computer jointly configured to process software instructions serially and/or in parallel. The computing device(s) 25 of the surgical suite 20 (FIG. 1A) may include and/or may interface with the computer(s) 37, 38. Further, the robot 27 may interface with the computers 37, 38.

The computers 37, 38 may be operable to communicate with one or more networks such as a network 39 comprised of one or more computing devices. The network 39 may be a private local area network (LAN), a private wide area network (WAN), the Internet, or a mesh network.

The host computer 37 and each client computer 38 may include one or more computer processors, memory, storage means, network devices, and input and/or output devices and/or interfaces. The input devices may include keyboards, mice and touch screens. The output devices may include monitors, speakers and printers. The memory may include UVPROM, EEPROM, FLASH, RAM, ROM, DVD, CD, a hard drive, or other computer readable medium which may store data and/or other information relating to the planning and implementation techniques disclosed herein. The computer processor(s) may be operable to individually and/or collectively execute any of the functionality disclosed herein.

The host computer 37 and each client computer 38 may be a desktop computer, laptop computer, smart phone, tablet, wearable (e.g., augmented reality) device, or any other computing device. The interface may be adapted to facilitate communication with the other systems and/or components of the network 39, including the various modules of the surgical suite 20 (FIG. 1A).

Each client computer 38 may be operable to communicate with the host computer 37 directly via a direct client interface or over the network 39. In another implementation, the client computers 38 may be operable to communicate with each other directly via a peer-to-peer interface.

The surgical system 36 may include, or may interface with, one or more imaging devices 40. The host computer 37 and/or client computer(s) 38 may be coupled to the imaging device(s) 40. Each imaging device 40 may be configured to capture or acquire imagery, including one or more images 41 of patient anatomy A and/or the anatomic simulacra 10 that may reside within a scan field (e.g., window) of the imaging device 40. The imagery may include two-dimensional (2D) and/or three-dimensional (3D) greyscale and/or color images 41. Various imaging devices 40 may be utilized, such as an X-ray machine, CT machine or MRI machine that may be operable to obtain one or more images of the anatomy A of the patient and/or the anatomic simulacra 10.

The client computers 38 may be operable to execute one or more software programs, including programs for controlling various surgical tools, which may include the robot 27. Each client computer 38 may be operable to access and locally and/or remotely execute a surgical (e.g., planning or guidance) environment 42. The surgical environment 42 may be a standalone software package or may be incorporated into another surgical tool. The surgical environment 42 may be configured to communicate with the host computer 37 either over the network 39 or directly through the direct client interface. In implementations, the host computer 37 may be operable to execute the surgical environment 42.

The surgical environment 42 may be operable to obtain (e.g., acquire) imagery of patient anatomy A and/or the anatomic simulacra 10, including one or more images 41. The surgical environment 42 may be operable to interact with one or more of the imaging devices 40 to capture, acquire or otherwise obtain image(s) 41 of patient anatomy A and/or the anatomic simulacra 10. The surgical environment 42 may be operable to provide a display (e.g., visualization) of one or more images 41, virtual anatomical (e.g., bone) models 43, and/or surgical device models including virtual surgical construct (e.g., implant or graft) models 44 and/or virtual surgical transfer (e.g., instrument or guide) models 45 via one or more graphical user interfaces (GUI). The anatomical model 43 may be representative of one or more bones and/or soft tissue, which may be associated with a respective joint. Each image 41, anatomical model 43, implant model 44, transfer model 45 and/or other data and information may be stored in one or more files or records according to a specified data structure. The implant model 44 may include one or more components. The implant model 44 may be associated with various implants, such as bases (e.g., base plates or trays) configured to be coupled to a respective articulation member, and bone plates configured to interconnect adjacent bones or bone fragments. The articulation member may have an articular surface dimensioned to mate with an articular surface of an opposed bone or implant. As described below, the client computers 38 may execute one or more software programs defined by the surgical environment 42.

The surgical system 36 may include at least one storage system 46, which may be operable to store or otherwise provide data to other computing devices. The storage system 46 may be a storage area network device (SAN) configured to communicate with the host computer 37 and/or the client computers 38 over the network 39. In implementations, the storage system 46 may be incorporated within, or may be directly coupled to, the host computer 37 and/or client computers 38. The storage system 46 may be configured to store various information, such as one or more computer software instructions, data, database files and configurations. In implementations, the storage system 46 may be remote (e.g., server or cloud-based storage) from the host computer 37 and/or client computers 38. The storage system 46 may be connected with the host computer 37 and/or client computers 38 through a network connection which may be wired or wireless.

In implementations, the surgical system 36 may be a client-server architecture configured to execute computer software on the host computer 37, which may be accessible by the client computers 38 using either a thin client application or a web browser executing on the client computers 38. The host computer 37 may be operable to load the computer software instructions from local storage, or from the storage system 46, into memory and may execute the computer software using the one or more computer processors. Other architectures may be utilized, including cloud computing.

The surgical system 36 may include one or more databases 47. The databases 47 may be stored at a central location, such as the storage system 46. In other implementations, one or more databases 47 may be stored at the host computer 37 and/or may be a distributed database provided by one or more of the client computers 38. Each database 47 may be a relational database configured to associate one or more images 41, anatomical models 43, implant models 44 and/or transfer models 45 to each other and/or a respective surgical plan(s) 48. Each surgical plan 48 may be associated with the anatomy of a respective patient and/or the anatomic simulacra 10. Each image 41, anatomical model 43, implant model 44, transfer model 45 and/or surgical plan 48 may be assigned a unique identifier or database entry. The database 47 may be configured to store data and other information corresponding to the images 41, anatomical models 43, implant models 44, transfer models 45 and/or surgical plans 48 in one or more database records or entries, and/or may be configured to link or otherwise associate one or more files corresponding to each respective image 41, anatomical model 43, implant model 44, transfer model 45 and/or surgical plan 48. Images 41, anatomical models 43, implant models 44, transfer models 45 and/or associated surgical plans 48 stored in the database(s) 47 may correspond to respective patient anatomies and/or the anatomic simulacra 10 from prior, planned and/or hypothetical surgical cases, and may be arranged into one or more predefined categories such as sex, age, race, ethnicity, defect category, procedure type, surgeon, and/or facility or organization.

Each image 41 and/or anatomical model 43 may include data and other information obtained from one or more medical devices or tools, such as the imaging devices 40. The anatomical model 43 may include coordinate information relating to an anatomy of the patient and/or the anatomic simulacra 10 obtained or derived from image(s) 41 captured or otherwise obtained by the imaging device(s) 40. Each implant model 44 and transfer model 45 may include geometry and/or coordinate information associated with a predefined design or a design established or modified by the surgical environment 42. The surgical environment 42 may incorporate and/or interface with one or more modeling packages, such as a computer aided design (CAD) package, to render the models 43, 44, 45 as 2D and/or 3D volumes or constructs, which may overlay one or more of the images 41 in a display window (e.g., screen) of a GUI.

The anatomical (e.g., bone or joint) model(s) 43 and/or implant model(s) 44 may be associated with a local coordinate (e.g., reference) system and/or a global (e.g., common) coordinate (e.g., reference) system. The surgical environment 42 may define the global coordinate system utilizing any of suitable technique. The global coordinate system may be associated with a set of coordinate values. The global coordinate system may include the localizer coordinate system LCS (FIG. 1A). In implementations, the global coordinate system may be representative of an anatomical position of the patient and/or the anatomic simulacra 10, which may be the same or may differ from an acquisition position associated with the image data which may be acquired by the imaging device(s) 40. The global coordinate system may be established with respect to Z (0, 0, 1), Y (0, 1, 0) and X (1, 0, 0) axes. The Z axis of the global coordinate system may correspond to a vertical direction. The X and Y axes of the global coordinate system may extend in respective horizontal directions along a horizontal plane. The global coordinate system may be established relative to one or more anatomical planes of the anatomy A and/or the anatomic simulacra 10. An orientation of the anatomical model(s) 43 relative to the global coordinate system may be representative of an anatomical (e.g., upright or vertical) position of the patient, or an anatomical position of the anatomic simulacra 10. The axes of the local and/or global coordinate systems may be established with respect to an acquisition orientation of the imagery associated with the imaging device(s) 40. The surgical environment 42 may be operable to register the anatomical model(s) 43 associated with the anatomy of a patient and/or the anatomic simulacra 10 from the respective local coordinate system to the global coordinate system. The surgical environment 42 may be operable to evaluate and/or display the anatomical model(s) 43 with respect to the local and/or global coordinate system, including establishing a surgical plan 48 and/or performing a range of motion simulation, which may be associated with one or more implant model(s) 44 placed relative to the anatomical model(s) 43.

The implant models 44 may correspond to (e.g., physical) implants and components of various configurations, shapes, sizes, procedures and/or instrumentation. The implant model 44 may be associated with a patient-specific implant for treating a single patient or particular patient associated with the anatomic simulacra 10, or may be non-patient specific (e.g., generic) for treating different patients or generic ones of the anatomic simulacra 10. Each implant may include, or may otherwise be associated with, one or more components that may be situated at a surgical site including grafts and various fixation devices such as screws, anchors, nails and suture. Each implant model 44 may correspond to a single (e.g., monolithic) component or may include two or more components that may be configured to establish an assembly. The implant model 44 may include a base (e.g., base plate or tray) coupled to an articulation member, bone plates configured to interconnect adjacent bones or bone fragments, intermedullary nails and/or suture anchors. The articulation member may have an articular surface dimensioned to mate with an articular surface of an opposed bone or implant. The implant(s), instrument(s) and/or associated component(s) may be formed of various materials, including metallic and/or non-metallic materials. Each anatomical model 43, implant model 44 and transfer model 45 may correspond to 2D and/or 3D geometry and may be utilized to generate a wireframe, mesh and/or solid construct in a display.

The transfer model(s) 45 may be associated with respective transfer devices. The transfer devices may include configurable (e.g., reusable), patient-specific and/or procedure specific devices. The transfer devices may include guides, which may be adapted to guide one or more surgical devices, including guide elements (e.g., K-wires and pins) and/or cutting instruments 35.

Each surgical plan 48 may be associated with one or more of the images 41, anatomical models 43, implant models 44 and/or transfer models 45. The surgical plan 48 may include various parameters associated with the respective images 41, anatomical models 43, implant models 44 and/or transfer models 45. The parameters may relate to characteristics associated with patient anatomy A and/or the anatomic simulacra 10 captured in the image(s) 41. The surgical plan 48 may include parameters including spatial information relating to relative placement and coordinate information of the selected anatomical model(s) 43, implant model(s) 44 and/or transfer model(s) 45.

The surgical plan 48 may include one or more revisions to an anatomical (e.g., bone, joint and/or the anatomic simulacra 10) model 43 and/or information relating to placement of an implant model 44 and/or transfer model 45 relative to the original and/or revised anatomical model 43. The surgical plan 48 may include coordinate information relating to the revised anatomical model 43 and a relative placement of the implant model 44 and/or transfer model 45 in predefined data structure(s). The surgical environment 42 may be operable to make one or more revisions to a transfer model 45 automatically or in response to user interaction with the user interface. Revisions to the anatomical model 43, implant model 44, transfer model 45 and/or surgical plan 48 may be stored in the database 47 automatically and/or in response to user interaction with the system 36.

One or more surgeons and other clinical users may be provided with a surgical environment 42 via the client computers 38 and may simultaneously access the image(s) 41, anatomical model(s) 43, implant model(s) 44, transfer model(s) 45 and/or surgical plan(s) 48 stored in the database(s) 47. Each user may interact with the surgical environment 42 to create, view, edit (e.g., modify) and/or approve various aspects of the surgical plan 48. Each client computer 38 may be configured to store local instances of the images 41, anatomical models 43, implant models 44, transfer models 45 and/or surgical plans 48, which may be synchronized in real-time or periodically with the database(s) 47. The surgical environment 42 may be a standalone software package executed on a client computer 38 or may be provided as one or more services executed on the host computer 37.

With reference to FIG. 1C, a system 100 for surgical training including the anatomic simulacra 102 is shown. In one example, the system 100 may include the anatomic simulacra 102 and optionally, a personal electronic device 104. The system 100 may also be included or used with the suite 20, including the robot 27. The anatomic simulacra 102 may be an anatomical synthetic specimen of a portion of a human or animal anatomy. It should be noted that while the anatomic simulacra 102 is described herein as comprising an anatomical synthetic specimen or anatomical model of a portion of a human or animal anatomy, the anatomic simulacra 102 may also be described as a synthetic specimen. The anatomic simulacra 102 may be used in the place of a cadaveric specimen. The anatomic simulacra 102 may be constructed using additive manufacturing techniques and systems, such as 3D printing. In other examples, the anatomic simulacra 102 or portions thereof may be cast. Thus, it should be understood that other manufacturing processes, including other additive manufacturing (AM) techniques, may be employed to form the anatomic simulacra 102. In one example, the anatomic simulacra 102 may be formed using vat photopolymerization (VPP), in which ultraviolet (UV) light may be used to cure liquid photopolymer resins. For example, the UV light may cure the photopolymer resin layer by layer, and a platform may move as more layers are built on top of one another, within a build tray. The anatomic simulacra 102 may be composed of a predetermined mixture of polymer-based materials, and the anatomic simulacra 102 may be constructed with predetermined fill patterns or densities to have different characteristics to simulate different human or animal anatomical structures. In one example, the anatomic simulacra 102 may be composed of suitable polymer-based materials, including, but not limited to silicon, urethane, photopolymer resins, etc.

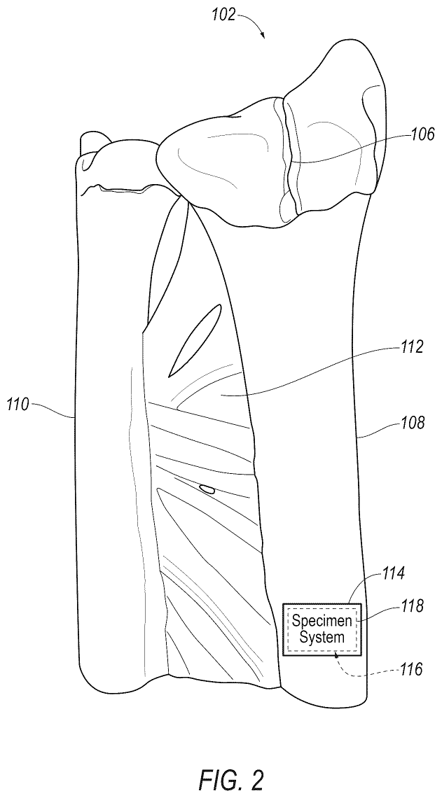

With reference to FIG. 2, an example of the anatomic simulacra 102 is shown. In this example, the anatomic simulacra 102 is a radioulnar joint, however, it should be noted that the anatomic simulacra 102 may comprise any suitable synthetic anatomical structure, including, but not limited to synthetic glenohumeral joints, a synthetic talocrural joint, a radiocarpal joint, an acetabulofemoral joint, a knee joint, etc. The anatomic simulacra 102 may include at least one characteristic 106, including, but not limited to, a density, a fracture pattern, a porosity, a pathology, a simulated age and the like. In the example of FIG. 2, the characteristic 106 may comprise a facture pattern. It should be noted that in certain examples, the characteristic 106 may not be observable upon inspection to provide a predefined training experience for the trainee. In addition, it should be noted that while anatomic simulacra 102 is described herein as comprising an anatomical joint, the anatomic simulacra 102 may comprise a portion of an anatomy and need not include an anatomical joint. Generally, the anatomic simulacra 102 may include at least a synthetic portion of an anatomy.

In the example of FIG. 2, the anatomic simulacra 102 includes a synthetic radius 108, a synthetic ulna 110 and a synthetic interosseous membrane 112. In other examples, the anatomic simulacra 102 may include synthetic nerves or synthetic portions of a human or animal nervous system, synthetic blood vessels or synthetic portions of a human or animal vascular system, synthetic integumentary system or synthetic portions of a human or animal integumentary system, etc. In certain instances, the anatomic simulacra 102 may also include an identification tag 114. The identification tag 114 may be coupled to the anatomic simulacra 102 at a location that is spaced a distance apart from a predetermined location for the surgical training procedure associated with the anatomic simulacra 102 and in certain instances, may be spaced a distance apart from the characteristic 106. Generally, the identification tag 114 may include a logo associated with the manufacturer of the anatomic simulacra 102, a Trademark associated with the anatomic simulacra 102 and/or the manufacturer, and the like. In one example, a specimen system 116 may be coupled to the anatomic simulacra 102 so as to be disposed beneath or in proximity to the identification tag 114. Thus, the identification tag 114 may provide a visual locator for the position of the specimen system 116, which may be embedded within the anatomic simulacra 102.

For example, during the manufacture of the anatomic simulacra 102, a receptacle 118 may be defined, which may receive the specimen system 116. As a further example, in the instance of an additively manufactured anatomic simulacra 102, the anatomic simulacra 102 may be printed to include the receptacle 118. In the instance of a cast anatomic simulacra 102, the casting may define the receptacle 118 in the anatomic simulacra 102. The receptacle 118 may be sealed by the coupling of the identification tag 114 to the anatomic simulacra 102 to enclose the receptacle 118 via adhesives, ultrasonic welding or the like. Alternatively, in the example of the anatomic simulacra 102 being additively manufactured, the specimen system 116 may be positioned within the receptacle 118 and the additive manufacturing may continue to form a remainder of the anatomic simulacra 102, which encloses or encapsulates the specimen system 116 within the anatomic simulacra 102. In the example of the anatomic simulacra 102 being cast, the anatomic simulacra 102 may be cast about the specimen system 116. Thus, generally, the specimen system 116 may be embedded within the anatomic simulacra 102. In this example, the specimen system 116 may be embedded within the synthetic radius 108, but in other examples, the specimen system 116 may be embedded in the synthetic ulna 110. It should be understood that the specimen system 116 may generally be embedded within the anatomic simulacra 102 at any location that does not interfere with or hinder the surgical training procedure associated with the anatomic simulacra 102.

With reference back to FIG. 1C, the specimen system 116 may include sensor(s) or at least one sensor 130, a communication system 132 and a controller 134. The specimen system 116 may be contained within a housing 136 to protect the specimen system 116 during the installation or embedding of the specimen system 116 within the anatomic simulacra 102. The housing 136 may be composed of any suitable polymer-based material, however, any suitable material may be used. It should be noted that the housing 136 may have any suitable shape, and in certain instances, may comprise an enclosure such as an elastomeric sealing structure that envelops the specimen system 116 to seal the specimen system 116 from moisture, debris, particles and the like.

The sensor 130 may comprise any suitable sensor for observing the anatomic simulacra 102 and generating sensor signals based thereon. The at least one sensor 130 may comprise one or more of a force sensor, a strain sensor, a pressure sensor, an accelerometer, a temperature sensor and the like. For example, the at least one sensor 130 may comprise a piezoelectric sensor, which observes a pressure, a force, an acceleration and/or a strain associated with a portion of the anatomic simulacra 102. The at least one sensor 130 may also comprise a temperature sensor, such as a thermistor, which may observe a temperature associated with a portion of the anatomic simulacra 102. The at least one sensor 130 may be in communication with the controller 134 over a suitable communication architecture, which enables the transfer of data, power, etc. In the example of the sensor 130 being in wired communication with the controller 134, the wire may also be embedded within the anatomic simulacra 102.

The communication system 132 may be coupled to the anatomic simulacra 102. The communication system 132 may be in communication with the controller 134, and may transmit data from the controller 134, such as the sensor data, to the personal electronic device 104, the computing devices 25, the computers 37, 38 and/or the robot 27, for example. The communication system 132 may also receive data from the personal electronic device 104, the computing devices 25, the computers 37, 38 and/or the robot 27 and may transmit the received data to the controller 134. In one example, the controller 134 may be configured to wirelessly communicate with the personal electronic device 104, the computing devices 25, the computers 37, 38 and the robot 27. Thus, in certain examples, the communication system 132 may comprise a two-way communication system, which may be configured to transfer and receive data from the personal electronic device 104, the computing devices 25, the computers 37, 38 and/or the robot 27. In an example, the communication system 132 may comprise a Bluetooth low energy (BLE) transmitter or transceiver, a near field communication (NFC) transmitter or transceiver, a radio frequency (RF) radio transmitter or transceiver, a far field communication transmitter or transceiver, a wireless communication system configured to communicate via a wireless local area network (WLAN) using IEEE 802.11 standards or by using cellular data communication, a Bluetooth transmitter or transceiver, etc. Generally, the controller 134 may communicate data regarding the anatomic simulacra 102 to an external device, such as the personal electronic device 104, the computing devices 25, the computers 37, 38 and/or the robot 27.

The controller 134 may include at least one processor 140 and a computer-readable storage device or media 142. The processor 140 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 134, a semiconductor-based microprocessor (in the form of a microchip or chip set), any combination thereof, or generally any device for executing instructions. The computer readable storage device or media 142 may include volatile and nonvolatile storage in read-only memory (ROM), random-access memory (RAM), and keep-alive memory (KAM), for example. KAM is a persistent or non-volatile memory that may be used to store various operating variables while the processor 140 is powered down. The computer-readable storage device or media 142 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the communication system 132 in controlling features of the anatomic simulacra 102. In various examples, the controller 134 may be configured to implement instructions of a specimen control system 200 as described in detail below.

In various examples, the controller 134 may be configured to implement instructions to receive sensor signals from the at least one sensor 130, and to transmit the sensor signals to the personal electronic device 104, the computing devices 25, the computers 37, 38 and/or the robot 27 via the communication system 132. In addition, the controller 134 may be optionally configured to implement instructions to transmit data regarding the anatomic simulacra 102 to the personal electronic device 104, the computing devices 25, the computers 37, 38 and/or the robot 27 via the communication system 132.

The personal electronic device 104 may display data regarding the anatomic simulacra 102. Generally, the personal electronic device 104 may comprise any suitable electronic device, including, but not limited to, a computer, a tablet, a cellular phone, a smart watch, smartglasses, an augmented reality headset, etc. In one example, the personal electronic device 104 may include at least a human-machine interface 150, a device communication system 152 and a device controller 154.

The human-machine interface 150 may be in communication with the device controller 154 via a suitable communication medium. The human-machine interface 150 may be configured in a variety of ways. In some examples, the human-machine interface 150 may include a touchscreen interface 160 that may be overlaid on at least a portion of a display 162, various switches, one or more buttons, a keyboard, an audible device, a microphone associated with a speech recognition system, or various other human-machine interface devices.

In one example, the touchscreen interface 160 may receive input from the user, such as a request to receive data regarding the anatomic simulacra 102, etc. The touchscreen interface 160 may include, but is not limited to, a resistive touchscreen panel, a capacitive touchscreen panel, a projected capacitance touchscreen panel, a surface capacitive touchscreen panel, a surface acoustic wave touchscreen panel, etc. The display 162 may comprise any suitable technology for displaying information, including, but not limited to, a liquid crystal display (LCD), organic light emitting diode (OLED), plasma, etc. In this example, the display 162 may be an electronic display capable of graphically displaying one or more user interfaces under the control of the device controller 154. The display 162 may be in communication with the device controller 154 via a suitable communication medium. Those skilled in the art may realize other techniques to implement the display 162 in the personal electronic device 104.

Generally, upon the receipt input from the user, the human-machine interface 150 transmits a signal to the device controller 154. As will be discussed, the device controller 154 processes the signal, and may request the data regarding the anatomic simulacra 102 via the device communication system 152.

The device communication system 152 may be coupled to the personal electronic device 104 and may be configured to wirelessly communicate data between the personal electronic device 104 and the anatomic simulacra 102. The device communication system 152 may also communicate data to the computing devices 25, the computers 37, 38 and/or the robot 27. In certain examples, the device communication system 152 may comprise a two-way communication system, which may be configured to transfer and receive data from the anatomic simulacra 102, the computing devices 25, the computers 37, 38 and/or the robot 27. In an example, the device communication system 152 may comprise one or more of a Bluetooth low energy (BLE) transceiver, a near field communication (NFC) transceiver, a radio frequency (RF) radio transceiver, a far field communication transceiver, a wireless communication system configured to communicate via a wireless local area network (WLAN) using IEEE 802.11 standards or by using cellular data communication, a Bluetooth transceiver, etc. The device communication system 152 may also be in communication with the device controller 154.

The device controller 154 may include at least one processor 164 and a computer-readable storage device or media 166. The processor 164 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the device controller 154, a semiconductor-based microprocessor (in the form of a microchip or chip set), any combination thereof, or generally any device for executing instructions. The computer readable storage device or media 166 may include volatile and nonvolatile storage in read-only memory (ROM), random-access memory (RAM), and keep-alive memory (KAM), for example. KAM is a persistent or non-volatile memory that may be used to store various operating variables while the processor 164 is powered down. The computer-readable storage device or media 166 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the device controller 154 in controlling the personal electronic device 104. Generally, the device controller 154 may be configured to display one or more user interfaces associated with the anatomic simulacra 102. In various examples, device controller 154 may be configured to implement instructions of a device control system 250 as described in detail below.

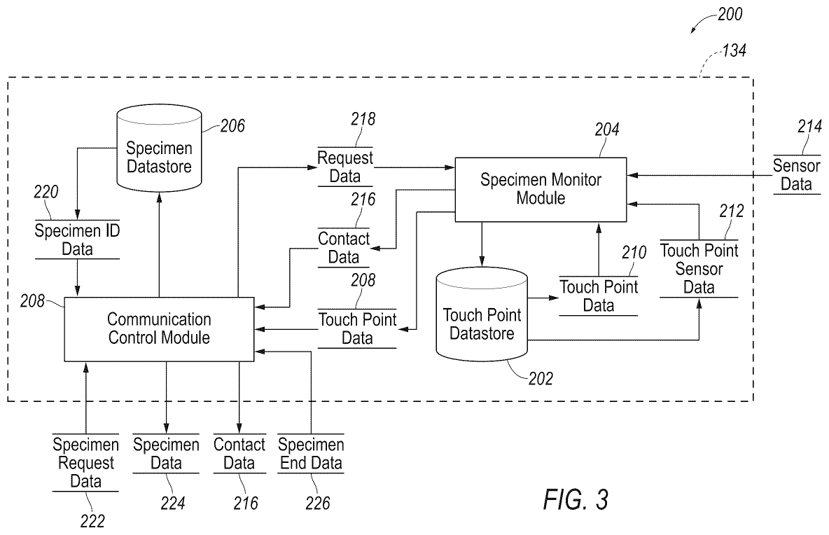

For example, as shown in more detail with regard to FIG. 3 and with continued reference to FIGS. 1 and 2, a dataflow diagram illustrates various examples of the specimen control system 200, which may be embedded within the controller 134. Various examples of the specimen control system 200 according to the present disclosure can include any number of sub-modules embedded within the controller 134. As can be appreciated, the sub-modules shown in FIG. 3 can be combined and/or further partitioned to similarly control features associated with the anatomic simulacra 102. Inputs to the specimen control system 200 may be received from the at least one sensor 130 (FIG. 1C), the personal electronic device 104, received from other control modules (not shown) associated with the anatomic simulacra 102, received from the surgical suite 20 (FIG. 1A) and/or determined/modeled by other sub-modules (not shown) within the controller 134. In various examples, the specimen control system 200 includes a touch point datastore 202, a specimen monitor module 204, a specimen datastore 206 and a communication control module 208.

The touch point datastore 202 may comprise data of a list of touch points associated with the anatomic simulacra 102. Stated another way, the touch point datastore 202 may store a three-dimensional coordinate location of each touch point or touch point data 210 associated with the anatomic simulacra 102. The three-dimensional coordinate locations of the touch points may be known, predefined or factory set locations based on the three-dimensional structure of the anatomic simulacra 102. Generally, the touch points denote areas in the anatomic simulacra 102 that may be contacted or touched by a surgeon, an instrument, such as the surgical instrument 32, the robot 27, an implant or the like during a surgical training procedure on the anatomic simulacra 102.

In one example, the touch point datastore 202 may also store touch point sensor data 212. The touch point datastore 202 may store one or more tables (e.g., lookup tables) that indicate a touch point that corresponds with a particular one of the sensors 130. Generally, each one of the sensors 130 may be associated with each one of the touch points so that contact to the touch points may be observed by the respective one of the sensors 130. In various examples, the tables may be defined by one or more indexes. The touch point sensor data 212 provided by at least one of the tables may indicate the touch point associated with the sensor 130 from which sensor data 214 is received. As an example, one or more tables can be indexed by various parameters such as, but not limited to, the sensors 130, to provide the touch point sensor data 212.

The specimen monitor module 204 may receive as input the sensor data 214. The sensor data 214 may comprise the sensor signals from one or more of the sensors 130. The specimen monitor module 204 may process the sensor data 214 and may determine which of the sensors 130 generated the sensor signals. The specimen monitor module 204 may query the touch point datastore 202 and retrieve the touch point sensor data 212 based on the sensor 130 associated with the sensor data 214. The specimen monitor module 204 may associate the sensor data 214 with the respective touch point and may set this data as contact data 216 for the communication control module 208. The contact data 216 may comprise the sensor signals observed by the sensor 130 at the associated touch point.

The specimen monitor module 204 may also receive as input request data 218. The request data 218 may comprise a request for information regarding the anatomic simulacra 102. Based on the request data 218, the specimen monitor module 204 may set the touch point data 210 for the communication control module 208.

The specimen datastore 206 may store data associated with the anatomic simulacra 102. For example, the specimen datastore 206 may store specimen identification data 220, which provides information regarding the anatomic simulacra 102 including, but not limited to, the type of anatomic simulacra 102, the characteristic 106 associated with the anatomic simulacra 102, a model number associated with the anatomic simulacra 102, etc. The specimen identification data 220 may be predefined, factory set data.

The communication control module 208 receives as input specimen request data 222. The specimen request data 222 may comprise a request for data regarding the anatomic simulacra 102, which may be received from the personal electronic device 104. The specimen request data 222 may also be received from the computing devices 25, the computers 37, 38 and/or the robot 27. Based on the specimen request data 222, the communication control module 208 may query the specimen datastore 206 and retrieve the specimen identification data 220. Based on the specimen request data 222, the communication control module 208 may also set the request data 218 for the specimen monitor module 204.

The communication control module 208 may also receive as input the touch point data 210 from the specimen monitor module 204. The communication control module 208 may compile the specimen identification data 220 with the touch point data 210 and may output this data as specimen data 224. The specimen data 224 may comprise the information regarding the anatomic simulacra 102, along with the three-dimensional coordinate locations of the touch points associated with the anatomic simulacra 102.

The communication control module 208 may also receive as input the contact data 216 from the specimen monitor module 204. Based on the receipt of the contact data 216, the communication control module 208 may also output the contact data 216 for the personal electronic device 104, the computing devices 25, the computers 37, 38 and/or the robot 27.

The communication control module 208 may receive as input specimen end data 226. Based on the specimen end data 226, the communication control module 208 may cease monitoring for the receipt of the contact data 216 from the specimen monitor module 204.

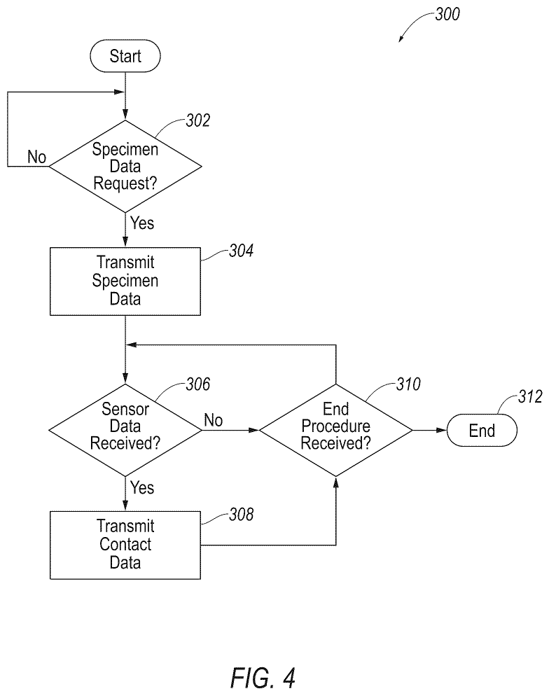

Referring now to FIG. 4, and with continued reference to FIGS. 1-3, a flowchart illustrates a method 300 that can be performed by the specimen control system 200 of FIG. 4 in accordance with the present disclosure. In one example, the method 300 is performed by the processor 140 of the controller 134 of the anatomic simulacra 102. As can be appreciated in light of the disclosure, the order of operation within the method 300 is not limited to the sequential execution as illustrated in FIG. 4, but may be performed in one or more varying orders as applicable and in accordance with the present disclosure. In various examples, the method 300 may run based on receipt of the specimen request data 222.

At 302, the method may determine whether a request for specimen data or the specimen request data 222 has been received. If true, the method may proceed to 304. Otherwise, the method may loop.

At 304, the method may transmit the specimen data 224 to the personal electronic device 104, for example. The method may also transmit the specimen data 224 to the computing devices 25, the computers 37, 38 and/or the robot 27. At 306, the method may determine whether sensor data 214 has been received from the at least one sensor 130. If true, the method may proceed to 308. Otherwise, at 310, the method may determine whether specimen end data 226 has been received. If so, the method may end at 312. At 308, the method may output or transmit the contact data 216 to the personal electronic device 104, the computing devices 25, the computers 37, 38 and/or the robot 27, for example. The method may proceed to 310.

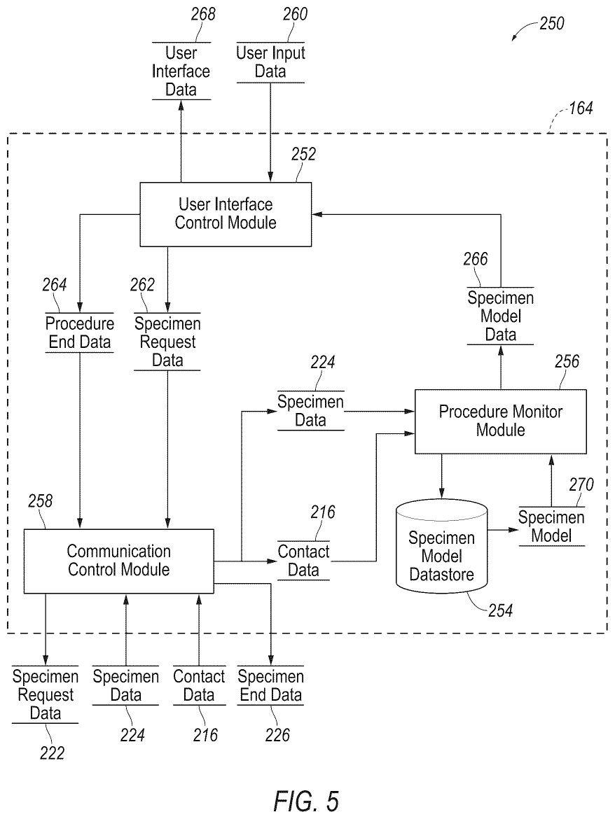

As shown in more detail with regard to FIG. 5 and with continued reference to FIGS. 1-4, a dataflow diagram illustrates various examples of the device control system 250, which may be embedded within the device controller 154. Various examples of the device control system 250 according to the present disclosure can include any number of sub-modules embedded within the device controller 154. As can be appreciated, the sub-modules shown in FIG. 5 can be combined and/or further partitioned to similarly control the personal electronic device 104. Inputs to the device control system 250 may be received from the human-machine interface 150 (FIG. 1C), the anatomic simulacra 102 (FIG. 1C), received from other control modules (not shown) associated with the personal electronic device 104, received from the surgical suite 20 (FIG. 1A) and/or determined/modeled by other sub-modules (not shown) within the device controller 154. In various examples, the device control system 250 may include a user interface control module 252, a specimen model datastore 254, a procedure monitor module 256 and a device communication control module 258.

The user interface control module 252 may receive user input data 260. The user input data 260 may be received from a user's interaction with the human-machine interface 150. The user interface control module 252 may process the user input data 260 and may set specimen request data 262 for the device communication control module 258. The specimen request data 262 may comprise a request for information or data regarding the anatomic simulacra 102. The user interface control module 252 may also process the user input data 260 and may set procedure end data 264 for the device communication control module 258. The procedure end data 264 may comprise data that the user has completed the surgical training procedure associated with the anatomic simulacra 102 such that the user may be done using the anatomic simulacra 102.

The user interface control module 252 may also receive as input specimen model data 266 from the procedure monitor module 256. The specimen model data 266 may comprise data of a three-dimensional model of the anatomic simulacra 102, which may include the touch points associated with the anatomic simulacra 102. The specimen model data 266 may also include sensor data associated with one or more of the touch points based on contact made to the respective one of the touch points. The three-dimensional model of the anatomic simulacra 102 may include three-dimensional coordinate values for the anatomic simulacra 102. Based on the specimen model data 266, the user interface control module 252 may output user interface data 268 for display on the display 162 associated with the human-machine interface 150. The user interface data 268 may comprise a graphical representation of the three-dimensional model of the anatomic simulacra 102, with the touch points and the sensor data, which may be overlayed or superimposed on the three-dimensional model of the anatomic simulacra 102. In addition, the user interface control module 252 may output the user interface data 268 for display on one or more of the displays 34 associated with the surgical suite 20.

The specimen model datastore 254 may store one or more tables (e.g., lookup tables) that indicate a three-dimensional model that corresponds with a particular synthetic specimen or anatomic simulacra. Generally, the personal electronic device 104 may be used with various synthetic specimens or anatomic simulacra 102, and each one of the synthetic specimens or anatomic simulacra 102 may be associated with each one of the three-dimensional models. In various examples, the tables may be defined by one or more indexes. A specimen model 270 provided by at least one of the tables may provide data of a three-dimensional model associated with the anatomic simulacra 102, which may include three-dimensional coordinate locations for features associated with the anatomic simulacra 102. As an example, one or more tables can be indexed by various parameters such as, but not limited to, the model number of the anatomic simulacra 102, to provide the specimen model 270.

The procedure monitor module 256 may receive as input the specimen data 224. Based on the specimen data 224, the procedure monitor module 256 may query the specimen model datastore 254 and retrieve the specimen model 270 associated with the specimen data 224. The procedure monitor module 256 may associate the three-dimensional coordinate locations associated with each of the touch points of the anatomic simulacra 102 with the three-dimensional model of the anatomic simulacra 102 based on the specimen data 224. The procedure monitor module 256 may set the three-dimensional model, with the touch points associated with the anatomic simulacra 102 as the specimen model data 266 for the user interface control module 252.

The procedure monitor module 256 may also receive as input the contact data 216. Based on the contact data 216, the procedure monitor module 256 may associate the sensor data received from the respective sensor 130 with the respective touch point and set the three-dimensional model, with the touch points associated with the anatomic simulacra 102 and the sensor data associated with the particular touch point(s) as the specimen model data 266 for the user interface control module 252.

The device communication control module 258 may receive as input the specimen data 224 and the contact data 216 from the communication system 132. The device communication control module 258 may set the specimen data 224 and the contact data 216 for the procedure monitor module 256. The device communication control module 258 may output the specimen request data 222 and the specimen end data 226 for the communication system 132 of the anatomic simulacra 102.

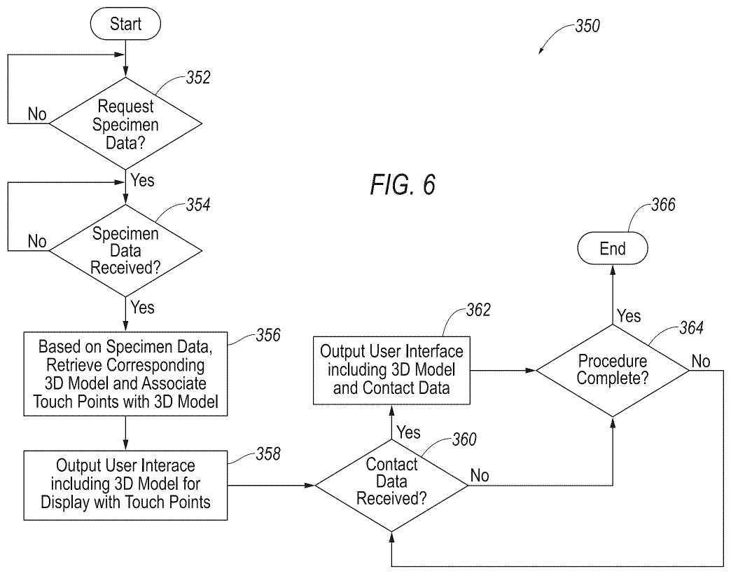

Referring now to FIG. 6, and with continued reference to FIGS. 1-5, a flowchart illustrates a method 350 that can be performed by the device control system 250 of FIG. 5 in accordance with the present disclosure. In one example, the method 350 is performed by the processor 164 of the device controller 154 of the personal electronic device 104. As can be appreciated in light of the disclosure, the order of operation within the method 350 is not limited to the sequential execution as illustrated in FIG. 6, but may be performed in one or more varying orders as applicable and in accordance with the present disclosure. In various examples, the method 350 may run based on an activation of the personal electronic device 104.

At 352, the method may determine whether the user input data 260 has been received that requests information regarding the anatomic simulacra 102. If true, the method may proceed to 354. Otherwise, the method loops.

At 354, the method may determine whether the specimen data 224 has been received from the communication system 132 of the anatomic simulacra 102. If true, the method may proceed to 356. Otherwise, the method loops.

At 356, based on the specimen data 224, the method may query the specimen model datastore 254 and retrieve the specimen model 270 that corresponds with the specimen data 224. The method may associate the touch points with the three-dimensional model of the anatomic simulacra 102 based on the specimen data 224. At 358, the method may output the user interface data 268, which includes the three-dimensional model of the anatomic simulacra 102 with each of the touch points for display on the display 162.

At 360, the method may determine whether the contact data 216 has been received from the anatomic simulacra 102. If true, the method may proceed to 362. Otherwise, the method may proceed to 364. At 362, the method may associate the contact data 216 or the sensor data from the respective sensor(s) 130 with the respective touch points and output the three-dimensional model with the touch points and the sensor data for display on the display 162. The method may also output the three-dimensional model with the touch points and the sensor data for display on one or more of the displays 34.

At 364, the method may determine whether the procedure has ended based on the user input data 260. If true, the method may output the data 226 to the communication system 132 of the anatomic simulacra 102 and may end at 366. Otherwise, the method may loop.

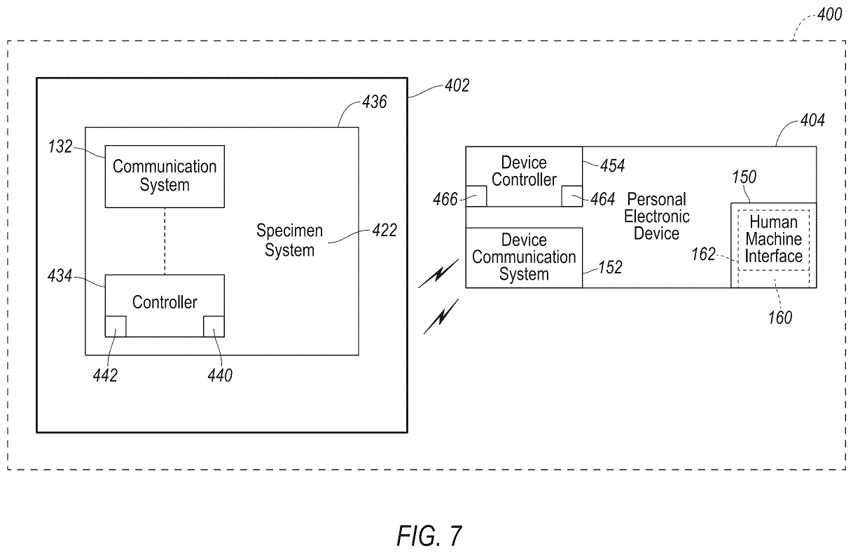

It should be noted that while the system 100 has been described and illustrated herein as including the anatomic simulacra 102 and the personal electronic device 104, a system may be configured differently for surgical training. For example, with reference to FIG. 7, a system 400 is shown. As the system 400 may include similar or the same components as the system 100, the same reference numerals will be used to denote the similar or the same components. The system 400 may include the anatomic simulacra 402 and optionally, a personal electronic device 404. The system 400 may be used or provided with the surgical suite 20. The anatomic simulacra 402 may be an anatomical synthetic specimen or anatomic model of a portion of a human or animal anatomy, similar to the anatomic simulacra 102. The anatomic simulacra 402 may be used in the place of a cadaveric specimen. The anatomic simulacra 402 may be constructed using additive manufacturing techniques and systems, such as 3D printing. In other examples, the anatomic simulacra 402 or portions thereof may be cast. Thus, it should be understood that other manufacturing processes, including other additive manufacturing (AM) techniques, may be employed to form the anatomic simulacra 402. In one example, the anatomic simulacra 402 may be formed using vat photopolymerization (VPP). The anatomic simulacra 402 may be composed of a predetermined mixture of polymer-based materials, and the anatomic simulacra 402 may be constructed with predetermined fill patterns or densities to have different characteristics to simulate different human or animal anatomical structures. In one example, the anatomic simulacra 402 may be composed of suitable polymer-based materials, including, but not limited to silicon, photopolymer resins, etc.

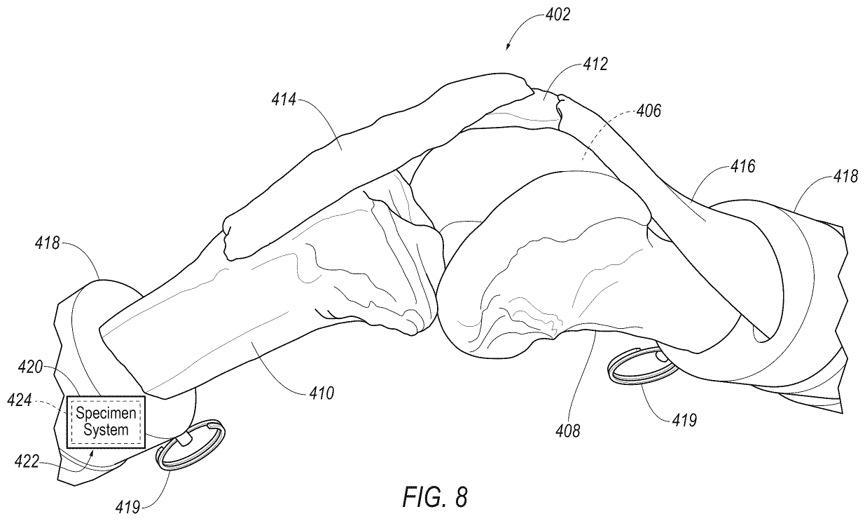

With reference to FIG. 8, an example of the anatomic simulacra 402 is shown. In this example, the anatomic simulacra 402 is a knee joint, however, it should be noted that the anatomic simulacra 402 may comprise any suitable synthetic anatomical structure, including, but not limited to synthetic glenohumeral joints, a synthetic talocrural joint, a radiocarpal joint, an acetabulofemoral joint, a radioulnar joint, etc. The anatomic simulacra 402 may include at least one characteristic 406, including, but not limited to, a density, a fracture pattern, a porosity, a pathology, a simulated age and the like. In the example of FIG. 8, the characteristic 406 may comprise a porosity and a pathology. It should be noted that in certain examples, the characteristic 406 may not be observable upon inspection to provide a predefined training experience for the trainee. In addition, it should be noted that while anatomic simulacra 402 is described herein as comprising an anatomical joint, the anatomic simulacra 402 may comprise a portion of an anatomy and need not include an anatomical joint. Generally, the anatomic simulacra 402 may include at least a synthetic portion of an anatomy.

In the example of FIG. 8, the anatomic simulacra 402 includes a synthetic femur 408, a synthetic tibia 410, a synthetic patella 412, a synthetic patellar ligament 414 and a synthetic quadriceps tendon 416. In other examples, the anatomic simulacra 402 may include synthetic nerves or synthetic portions of a human or animal nervous system, synthetic blood vessels or synthetic portions of a human or animal vascular system, synthetic integumentary system or synthetic portions of a human or animal integumentary system, etc. In certain instances, the anatomic simulacra 402 may also include a mounting portion 418 coupled to at least one or both of the synthetic femur 408 and the synthetic tibia 410. In this example, each of the synthetic femur 408 and the synthetic tibia 410 include the mounting portion 418. The mounting portion 418 may enable the anatomic simulacra 402 to be coupled to a workspace or the like to enable the surgical training procedure to be performed on the anatomic simulacra 402. The mounting portion 418 may be integrally formed with the anatomic simulacra 402, and may include an attachment feature 419, such as a loop, hook, pin, etc. for coupling the mounting portion 418 to the workspace. In other examples, the mounting portion 418 may be separately formed and coupled to the synthetic femur 408 and/or the synthetic tibia 410.

In one example, the mounting portion 418 of the synthetic tibia 410 may include an identification tag 420. The identification tag 420 may be coupled to the mounting portion 418 so as to be spaced a distance apart from the surgical training procedure associated with the anatomic simulacra 402. Generally, the identification tag 420 may include a logo associated with the manufacturer of the anatomic simulacra 402, a Trademark associated with the anatomic simulacra 402 and/or the manufacturer, and the like. In one example, a specimen system 422 may be coupled to the anatomic simulacra 402 so as to be disposed beneath or in proximity to the identification tag 420. The identification tag 420 may provide a visual locator for the position of the specimen system 422, which may be embedded within the anatomic simulacra 402.

For example, during the manufacture of the mounting portion 418, a receptacle 424 may be defined, which may receive the specimen system 422. As a further example, in the instance of an additively manufactured synthetic tibia 410 including the mounting portion 418, the mounting portion 418 may be printed to include the receptacle 424. In the instance of a cast mounting portion 418, the casting may define the receptacle 424 in the mounting portion 418. The receptacle 424 may be sealed by the coupling of the identification tag 420 to the anatomic simulacra 402 to enclose the receptacle 424 via adhesives, ultrasonic welding or the like. Alternatively, in the example of the mounting portion 418 being additively manufactured, the specimen system 422 may be positioned within the receptacle 424 and the additive manufacturing may continue to form a remainder of the mounting portion 418, which encloses the specimen system 422 within the anatomic simulacra 402. In the example of the mounting portion 418 being cast, the mounting portion 418 may be cast about the specimen system 422. Generally, the specimen system 422 may be embedded within the anatomic simulacra 402. In this example, the specimen system 422 may be embedded in the mounting portion 418 so as to be proximate to the synthetic tibia 410, but in other examples, the specimen system 422 may be embedded in the mounting portion 418 so as to be proximate to the synthetic femur 408 or may be embedded within the synthetic femur 408 or the synthetic tibia 410. It should be understood that the specimen system 422 may generally be embedded within the anatomic simulacra 402 at any location that does not interfere with or hinder the surgical training procedure associated with the anatomic simulacra 402.

With reference back to FIG. 7, the specimen system 422 may include the communication system 132 and a controller 434. The specimen system 422 may be contained within a housing 436 to protect the specimen system 422 during the installation or embedding of the specimen system 422 within the mounting portion 418. The housing 436 may be composed of any suitable polymer-based material, however, any suitable material may be used. It should be noted that the housing 436 may have any suitable shape, and in certain instances, may comprise an enclosure such as an elastomeric sealing structure that envelops the specimen system 422 to seal the specimen system 422 from moisture, debris, particles and the like.

Generally, the communication system 132 may be coupled to the anatomic simulacra 402, and in one example, may be coupled to the mounting portion 418. The communication system 132 may be in communication with the controller 434, and may transmit data from the controller 434, such as data regarding the anatomic simulacra 402, to the personal electronic device 404, the computing devices 25, the computers 37, 38 and/or the robot 27, for example. The communication system 132 may also receive data from the personal electronic device 404, the computing devices 25, the computers 37, 38 and/or the robot 27, and may transmit the received data to the controller 434. In one example, the communication system 132 may be configured to wirelessly communicate with the personal electronic device 404. Generally, the controller 134 may communicate data regarding the anatomic simulacra 402 to an external device, such as the personal electronic device 404, the computing devices 25, the computers 37, 38 and/or the robot 27.

The controller 434 may include at least one processor 440 and a computer-readable storage device or media 442. The processor 440 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 434, a semiconductor-based microprocessor (in the form of a microchip or chip set), any combination thereof, or generally any device for executing instructions. The computer readable storage device or media 442 may include volatile and nonvolatile storage in read-only memory (ROM), random-access memory (RAM), and keep-alive memory (KAM), for example. KAM is a persistent or non-volatile memory that may be used to store various operating variables while the processor 440 is powered down. The computer-readable storage device or media 442 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 434 in controlling features of the anatomic simulacra 402. In various examples, the controller 434 may be configured to implement instructions of a specimen control system 500 as described in detail below. In various examples, the controller 434 may be configured to implement instructions to transmit data regarding the anatomic simulacra 402 to the personal electronic device 404, the computing devices 25, the computers 37, 38 and/or the robot 27 via the communication system 132.

The personal electronic device 404 may display data regarding the anatomic simulacra 402. Generally, the personal electronic device 404 may comprise any suitable electronic device, including, but not limited to, a computer, a tablet, a cellular phone, a smart watch, smartglasses, an augmented reality headset, etc. In one example, the personal electronic device 404 may include the human-machine interface 150, the device communication system 152 and a device controller 454.

The human-machine interface 150 may be in communication with the device controller 154 via a suitable communication medium. The human-machine interface 150 may include the touchscreen interface 160 that may be overlaid on at least a portion of the display 162. The touchscreen interface 160 may receive input from the user, such as a request to receive data regarding the anatomic simulacra 402, etc. The display 162 may be an electronic display capable of graphically displaying one or more user interfaces under the control of the device controller 454. The display 162 may be in communication with the device controller 454 via a suitable communication medium. Those skilled in the art may realize other techniques to implement the display 162 in the personal electronic device 404. Generally, upon the receipt input from the user, the human-machine interface 150 transmits a signal to the device controller 454. As will be discussed, the device controller 454 processes the signal, and may request the data regarding the anatomic simulacra 402 via the device communication system 152.

The device communication system 152 may be coupled to the personal electronic device 404 and may be configured to wirelessly communicate data between the personal electronic device 404 and the anatomic simulacra 402. In certain examples, the device communication system 152 may comprise the two-way communication system, which may be configured to transfer and receive data from the anatomic simulacra 402, the computing devices 25, the computers 37, 38 and/or the robot 27. The device communication system 152 may also be in communication with the device controller 454.

The device controller 454 may include at least one processor 464 and a computer-readable storage device or media 466. The processor 464 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the device controller 454, a semiconductor-based microprocessor (in the form of a microchip or chip set), any combination thereof, or generally any device for executing instructions. The computer readable storage device or media 466 may include volatile and nonvolatile storage in read-only memory (ROM), random-access memory (RAM), and keep-alive memory (KAM), for example. KAM is a persistent or non-volatile memory that may be used to store various operating variables while the processor 464 is powered down. The computer-readable storage device or media 466 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the device controller 454 in controlling the personal electronic device 404. Generally, the device controller 454 may be configured to display one or more user interfaces associated with the anatomic simulacra 402. In various examples, device controller 454 may be configured to implement instructions of a device control system 550 as described in detail below.

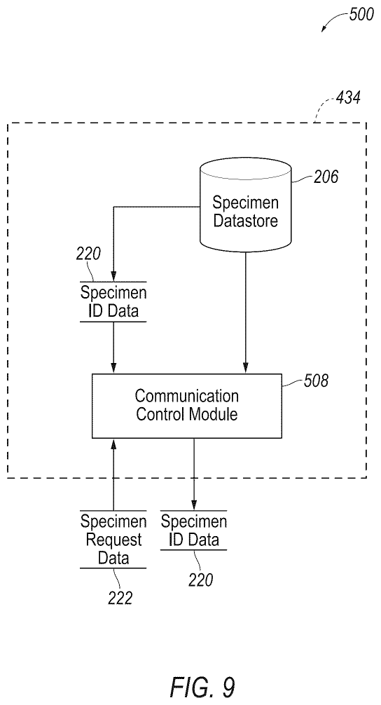

For example, as shown in more detail with regard to FIG. 9 and with continued reference to FIGS. 7 and 8, a dataflow diagram illustrates various examples of the specimen control system 500, which may be embedded within the controller 434. Various examples of the specimen control system 500 according to the present disclosure can include any number of sub-modules embedded within the controller 434. As can be appreciated, the sub-modules shown in FIG. 9 can be combined and/or further partitioned to similarly control features associated with the anatomic simulacra 402. Inputs to the specimen control system 500 may be received from the personal electronic device 404, received from other control modules (not shown) associated with the anatomic simulacra 402, received from the surgical suite 20 (FIG. 1A) and/or determined/modeled by other sub-modules (not shown) within the controller 434. In various examples, the specimen control system 500 includes the specimen datastore 206 and a communication control module 508.

The specimen datastore 206 may store data associated with the anatomic simulacra 402. For example, the specimen datastore 206 may store specimen identification data 220, which provides information regarding the anatomic simulacra 402 including, but not limited to the type of anatomic simulacra 402, the characteristic 406 associated with the anatomic simulacra 402, a model number associated with the anatomic simulacra 402, etc. The specimen identification data 220 may be predefined, factory set data.

The communication control module 508 receives as input the specimen request data 222. The specimen request data 222 may comprise the request for data regarding the anatomic simulacra 402, which may be received from the personal electronic device 404, the computing devices 25, the computers 37, 38 and/or the robot 27. Based on the specimen request data 222, the communication control module 508 may query the specimen datastore 206 and retrieve the specimen identification data 220. The communication control module 508 may output the specimen identification data 220 for the personal electronic device 404, the computing devices 25, the computers 37, 38 and/or the robot 27.

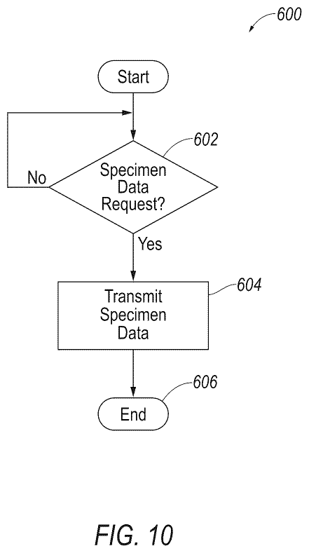

Referring now to FIG. 10, and with continued reference to FIGS. 7-9, a flowchart illustrates a method 600 that can be performed by the specimen control system 500 of FIG. 9 in accordance with the present disclosure. In one example, the method 600 is performed by the processor 440 of the controller 434 of the anatomic simulacra 402. As can be appreciated in light of the disclosure, the order of operation within the method 600 is not limited to the sequential execution as illustrated in FIG. 10, but may be performed in one or more varying orders as applicable and in accordance with the present disclosure. In various examples, the method 600 may run based on receipt of the specimen request data 222.

At 602, the method may determine whether a request for specimen data or the specimen request data 222 has been received. If true, the method may proceed to 604. Otherwise, the method may loop. At 604, the method may transmit the specimen identification data 220 to the personal electronic device 404, the computing devices 25, the computers 37, 38 and/or the robot 27, for example. The method may end at 606.

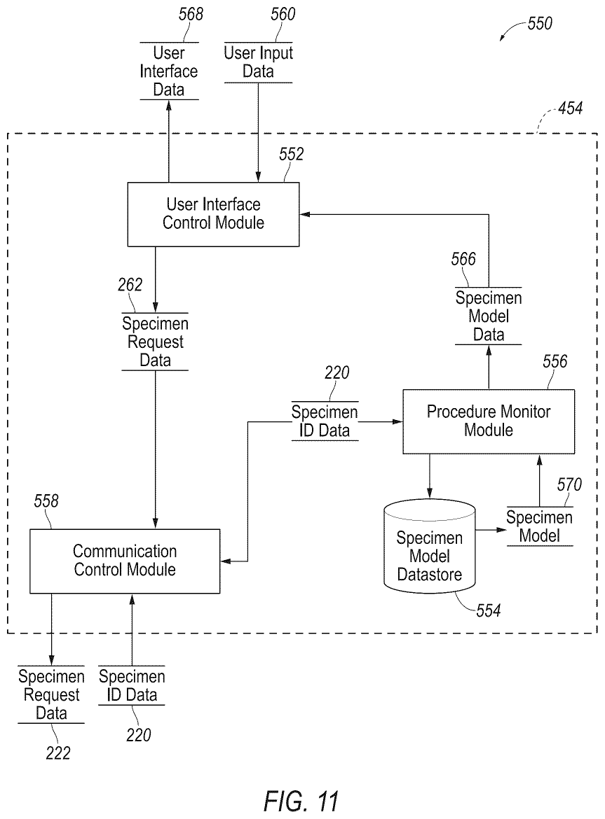

As shown in more detail with regard to FIG. 11 and with continued reference to FIGS. 7-9, a dataflow diagram illustrates various examples of the device control system 550, which may be embedded within the device controller 454. Various examples of the device control system 550 according to the present disclosure can include any number of sub-modules embedded within the device controller 454. As can be appreciated, the sub-modules shown in FIG. 11 can be combined and/or further partitioned to similarly control the personal electronic device 404. Inputs to the device control system 550 may be received from the human-machine interface 150 (FIG. 7), the anatomic simulacra 402 (FIG. 7), received from other control modules (not shown) associated with the personal electronic device 404, received from the surgical suite 20 (FIG. 1A) and/or determined/modeled by other sub-modules (not shown) within the device controller 454. In various examples, the device control system 550 may include a user interface control module 552, a specimen model datastore 554, a procedure monitor module 556 and a device communication control module 558.

The user interface control module 552 may receive user input data 560. The user input data 560 may be received from a user's interaction with the human-machine interface 150. The user interface control module 552 may process the user input data 560 and may set specimen request data 262 for the device communication control module 558. The specimen request data 262 may comprise the request for information or data regarding the anatomic simulacra 402.

The user interface control module 552 may also receive as input specimen model data 566 from the procedure monitor module 556. The specimen model data 566 may comprise data of a three-dimensional model of the anatomic simulacra 402. The three-dimensional model of the anatomic simulacra 402 may include three-dimensional coordinate values for the anatomic simulacra 402. Based on the specimen model data 566, the user interface control module 552 may output user interface data 568 for display on the display 162 associated with the human-machine interface 150. The user interface data 568 may comprise a graphical representation of the three-dimensional model of the anatomic simulacra 402. The user interface control module 252 may also output the user interface data 568 for display on one or more displays 34 associated with the surgical suite 20.

The specimen model datastore 254 may store one or more tables (e.g., lookup tables) that indicate a three-dimensional model that corresponds with a particular anatomic simulacra. Generally, the personal electronic device 404 may be used with various anatomic simulacra 402, and each one of the or anatomic simulacra 402 may be associated with each one of the three-dimensional models. In various examples, the tables may be defined by one or more indexes. A specimen model 570 provided by at least one of the tables may provide data of a three-dimensional model associated with the anatomic simulacra 402, which may include three-dimensional coordinate locations for features associated with the anatomic simulacra 402. As an example, one or more tables can be indexed by various parameters such as, but not limited to, the model number of the anatomic simulacra 402, to provide the specimen model 570.

The procedure monitor module 556 may receive as input the specimen identification data 220. Based on the specimen identification data 220, the procedure monitor module 556 may query the specimen model datastore 554 and retrieve the specimen model 570 associated with the specimen identification data 220. The procedure monitor module 556 may set the three-dimensional model as the specimen model data 566 for the user interface control module 552.

The device communication control module 558 may receive as input the specimen identification data 220 from the communication system 132. The device communication control module 558 may set the specimen identification data 220 for the procedure monitor module 556. The device communication control module 258 may output the specimen request data 222 for the communication system 132 of the anatomic simulacra 402.

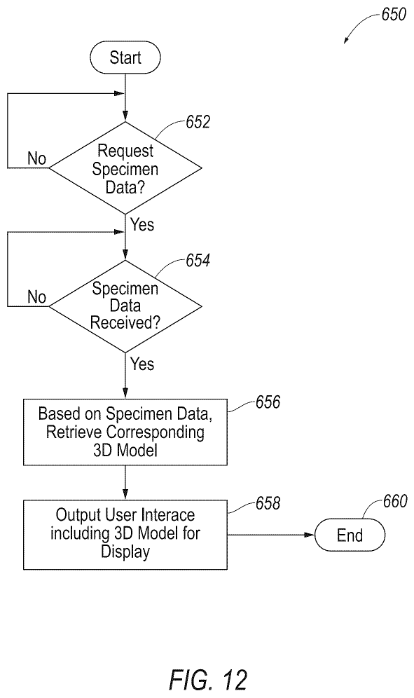

Referring now to FIG. 12, and with continued reference to FIGS. 7-10, a flowchart illustrates a method 650 that can be performed by the device control system 250 of FIG. 11 in accordance with the present disclosure. In one example, the method 650 is performed by the processor 464 of the device controller 454 of the personal electronic device 404. As can be appreciated in light of the disclosure, the order of operation within the method 650 is not limited to the sequential execution as illustrated in FIG. 12, but may be performed in one or more varying orders as applicable and in accordance with the present disclosure. In various examples, the method 650 may run based on an activation of the personal electronic device 404.

At 652, the method may determine whether the user input data 560 has been received that requests information regarding the anatomic simulacra 402. If true, the method may proceed to 654. Otherwise, the method may loop.

At 654, the method may determine whether the specimen identification data 220 has been received from the communication system 132 of the anatomic simulacra 402. If true, the method may proceed to 656. Otherwise, the method may loop.

At 656, based on the specimen identification data 220, the method may query the specimen model datastore 554 and retrieve the specimen model 570 that corresponds with the specimen identification data 220. At 658, the method may output the user interface data 568, which includes the three-dimensional model of the anatomic simulacra 102 for display on the display 162. The method may also output the user interface data 568 for display on one of the displays 34 associated with the surgical suite 20. The method may end at 660.

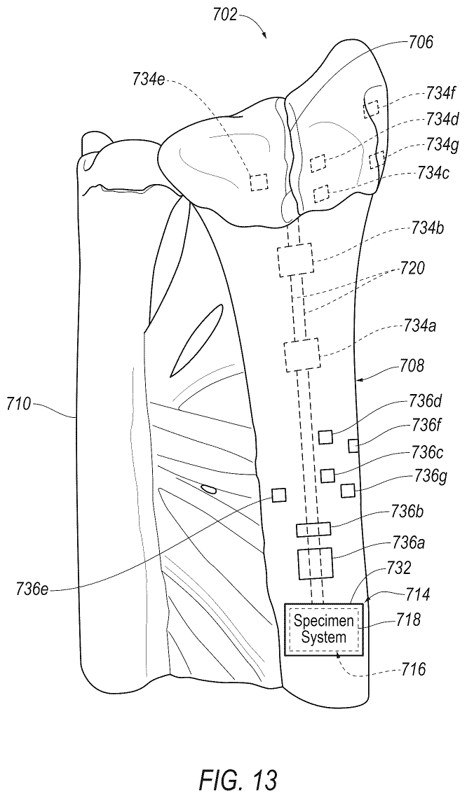

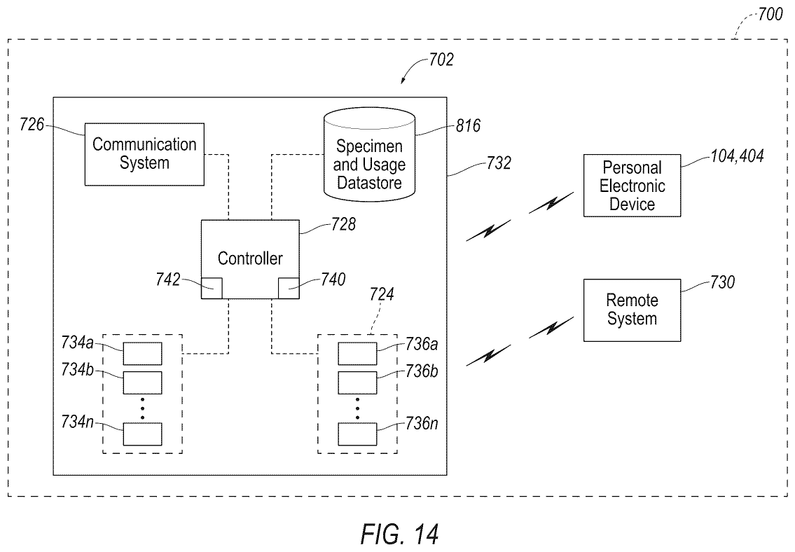

It should be noted that while the system 100 has been described and illustrated herein as including the anatomic simulacra 102 and the personal electronic device 104, a system may be configured differently for surgical training. For example, with reference to FIG. 13, a system 700 is shown. As the system 700 may include similar or the same components as the system 100, the same reference numerals will be used to denote the similar or the same components. The system 700 may include the anatomic simulacra 702. In certain examples, with additional reference to FIG. 14, the system 700 may include the personal electronic device 104, 404, and the system 700 may be used or provided with the surgical suite 20. The anatomic simulacra 702 may be an anatomical synthetic specimen or anatomic model of a portion of a human or animal anatomy, similar to the anatomic simulacra 102. The anatomic simulacra 702 may be used in the place of a cadaveric specimen. The anatomic simulacra 702 may be constructed using additive manufacturing techniques and systems, such as 3D printing. In other examples, the anatomic simulacra 702 or portions thereof may be cast. Thus, it should be understood that other manufacturing processes, including other additive manufacturing (AM) techniques, may be employed to form the anatomic simulacra 702. In one example, the anatomic simulacra 702 may be formed using vat photopolymerization (VPP). The anatomic simulacra 702 may be composed of a predetermined mixture of polymer-based materials, and the anatomic simulacra 702 may be constructed with predetermined fill patterns or densities to have different characteristics to simulate different human or animal anatomical structures. In one example, the anatomic simulacra 702 may be composed of suitable polymer-based materials, including, but not limited to silicon, photopolymer resins, etc.

With reference to FIG. 13, an example of the anatomic simulacra 702 is shown. In this example, the anatomic simulacra 702 is the radioulnar joint, however, it should be noted that the anatomic simulacra 702 may comprise any suitable synthetic anatomical structure, including, but not limited to synthetic glenohumeral joints, a synthetic talocrural joint, a radiocarpal joint, an acetabulofemoral joint, a knee joint, etc. The anatomic simulacra 702 may include at least one characteristic 706, including, but not limited to, a density, a fracture pattern, a porosity, a pathology, a simulated age and the like. In the example of FIG. 13, the characteristic 706 may comprise a facture pattern. It should be noted that in certain examples, the characteristic 706 may not be observable upon inspection to provide a predefined training experience for the trainee. In addition, it should be noted that while anatomic simulacra 702 is described herein as comprising an anatomical joint, the anatomic simulacra 702 may comprise a portion of an anatomy and need not include an anatomical joint. Generally, the anatomic simulacra 702 may include at least a synthetic portion of an anatomy.

In the example of FIG. 13, the anatomic simulacra 702 includes a synthetic radius 708, a synthetic ulna 710 and a synthetic interosseous membrane 712. In other examples, the anatomic simulacra 702 may include synthetic nerves or synthetic portions of a human or animal nervous system, synthetic blood vessels or synthetic portions of a human or animal vascular system, synthetic integumentary system or synthetic portions of a human or animal integumentary system, etc. In certain instances, the anatomic simulacra 702 may also include an identification tag 714. The identification tag 714 may be coupled to the anatomic simulacra 702 at a location that is spaced a distance apart from a predetermined location for the surgical training procedure associated with the anatomic simulacra 702 and in certain instances, may be spaced a distance apart from the characteristic 706. Generally, the identification tag 714 may include a logo associated with the manufacturer of the anatomic simulacra 702, a Trademark associated with the anatomic simulacra 702 and/or the manufacturer, and the like. In one example, a specimen system 716 may be coupled to the anatomic simulacra 702 so as to be at least partially disposed beneath or in proximity to the identification tag 714. Thus, the identification tag 714 may provide a visual locator for the position of the specimen system 716, which may be embedded within the anatomic simulacra 702.

For example, during the manufacture of the anatomic simulacra 702, a receptacle 718 and one or more passageways 720 may be defined, which may receive a respective portion of the specimen system 716. As a further example, in the instance of an additively manufactured anatomic simulacra 702, the anatomic simulacra 702 may be printed to include the receptacle 718 and the passageways 720. In the instance of a cast anatomic simulacra 702, the casting may define the receptacle 718 and the passageways 720 in the anatomic simulacra 702. The receptacle 718 may be sealed by the coupling of the identification tag 714 to the anatomic simulacra 702 to enclose the receptacle 718 via adhesives, ultrasonic welding or the like. Alternatively, in the example of the anatomic simulacra 702 being additively manufactured, a portion of the specimen system 716 may be positioned within the receptacle 718 and the passageways 720 and the additive manufacturing may continue to form a remainder of the anatomic simulacra 702, which encloses the portion of the specimen system 716 within the anatomic simulacra 702. In the example of the anatomic simulacra 702 being cast, the anatomic simulacra 702 may be cast about the portion of the specimen system 716. Thus, generally, at least a portion of the specimen system 716 may be embedded within the anatomic simulacra 702. In this example, the portion of the specimen system 716 may be embedded within the synthetic radius 708, but in other examples, the portion of the specimen system 716 may be embedded in the synthetic ulna 710. It should be understood that the portion of the specimen system 716 may generally be embedded within the anatomic simulacra 702 at any location that does not interfere with or hinder the surgical training procedure associated with the anatomic simulacra 702.

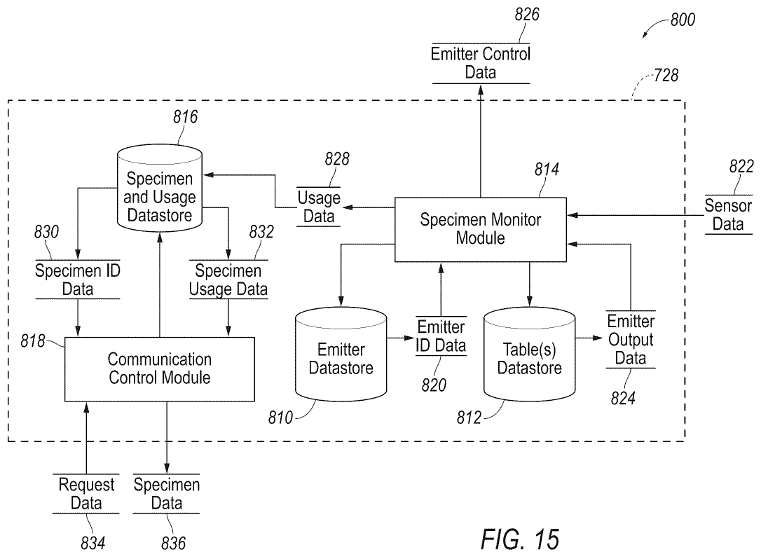

In one example, with additional reference to FIG. 14, the specimen system 716 may include a sensor system 722, a feedback system 724, a communication system 726 and a controller 728. The specimen system 716 may also include a specimen and usage datastore 816 (FIGS. 14 and 15). The communication system 726, the controller 728 and the specimen and usage datastore 816 of the specimen system 716 may be contained within a housing 732 to protect at least a portion of the specimen system 716 during the installation or embedding of the specimen system 716 within the anatomic simulacra 702. The housing 732 may be composed of any suitable polymer-based material, however, any suitable material may be used. It should be noted that the housing 732 may have any suitable shape, and in certain instances, may comprise an enclosure such as an elastomeric sealing structure that envelops the portion of the specimen system 716 to seal the portion of the specimen system 716 from moisture, debris, particles and the like.

The sensor system 722 may include a plurality of sensors 734a, 734b . . . 734n, which may be referred to herein as “sensors 734.” Generally, the sensors 734 are embedded within or coupled to the anatomic simulacra 702 so as to observe a portion of the anatomic simulacra 702 and generate sensor signals based thereon. For example, the sensors 734 are coupled to or embedded within the anatomic simulacra 702 so as to observe at least one of a pressure, a torque, a strain, a tension, a force, a temperature or the like associated with the respective portion of the anatomic simulacra 702. Thus, the sensors 734 may include, but are not limited to, a piezoelectric sensor, a pressure sensor, a torque sensor, a strain gauge, a tension meter, a force sensor, a temperature sensor, etc. Generally, each of the sensors 734 are coupled to or embedded within the anatomic simulacra 702 so as to be proximate at least one of the characteristic 706 and/or the surgical training procedure to be practiced with the anatomic simulacra 702 to observe the anatomic simulacra 702 during the performance of the surgical training procedure. By positioning the sensors 734 proximate the surfaces of the anatomic simulacra 702, the trainee performing the surgical training procedure may receive feedback, as will be discussed below, on the performance of the surgical training procedure, which may assist in learning the surgical procedure.

In the example of the anatomic simulacra 702 as shown in FIG. 13, the sensor system 722 includes sensors 734a-734g. It should be noted that the number of sensors 734 may vary based on the characteristic 706 and/or the anatomic simulacra 702. In the example of FIG. 13, the sensors 734a-734g are coupled to or embedded within the anatomic simulacra 702 so as to be proximate the characteristic 706 and to be proximate, beneath or at surfaces of the anatomic simulacra 702 to which an implant may be coupled during the surgical training procedure. In FIG. 13, the sensors 734a-734g may comprise torsion sensors, which observe a torque applied to the respective surface of the anatomic simulacra 702 during a surgical training procedure associated with the repair of the fracture pattern associated with the anatomic simulacra 702.

With reference to FIG. 14, the sensors 734 may be in communication with the controller 728 over a suitable communication architecture, which enables the transfer of data, power, etc. In the example of the sensor 734 being in wired communication with the controller 728, the wire may also be embedded within the anatomic simulacra 702.

The feedback system 724 may comprise any suitable system for providing a visual, audio and/or haptic response to the trainee during the performance of the surgical training procedure. The feedback system 724 may include a plurality of emitters 736a, 736b . . . 736n, which may be referred to herein as “emitters 736.” Each of the emitters 736 may comprise, but is not limited to, a light emitting element, such as a light emitting diode, a speaker, a buzzer, a vibration motor, a display, etc. Generally, each of the emitters 736 may be associated with a respective one of the sensors 734. By associating each of the emitters 736 with a respective one of the sensors 734, individualized feedback may be provided to the trainee during each observed portion of the surgical training procedure. Stated another way, the correspondence between the sensors 734 and the emitters 736 may provide a response for a particular step or action associated with the surgical training procedure, which may permit the trainee to adjust or modify the performance of the particular step based on the individualized feedback. This enables the trainee to adjust the performance of the surgical training procedure in substantially real-time, which may result in a predetermined or desired outcome for the surgical training procedure.

The emitters 736 may be coupled to the anatomic simulacra 702 in any desired manner. In the example of the emitter 736 that provides a visual output, the emitter 736 may be positioned at a location the anatomic simulacra 702 so as to be visible by the trainee during the surgical training procedure. For example, the emitter 736 may be coupled to the surface of the anatomic simulacra 702 so as to be spaced a distance apart from the surgical training procedure, but be visible as the trainee is performing the surgical training procedure. In the example of the emitter 736 that outputs an audible or haptic response, this type of emitter 736 may be at least partially embedded within the anatomic simulacra 702. In other examples, the anatomic simulacra 702 may include a base or mounting portion, similar to the mounting portion 418, which includes each of the emitters 736. In this example, the mounting portion may include labels that associate the emitters 736 with the portion of the anatomic simulacra 702 associated with the emitter 736 and/or the anatomic simulacra 702 and the emitters 736 may be color coded to provide a visual cue as to which portion of the anatomic simulacra 702 the emitter 736 is associated with. Thus, generally, the emitters 736 are coupled to the anatomic simulacra 702 and are associated with the sensors 734 to provide a visual, haptic or audio feedback to the trainee based on the sensor signals received from the sensors 734 during the surgical training procedure.

It should be noted, that while the emitters 736 are described herein as being associated with a respective one of the sensors 734, in certain instances, one of the emitters 736 may be associated with a group of the sensors 734. For example, the emitters 736 may be configured to provide feedback for a group of sensors along a surface of the anatomic simulacra 702 or to provide feedback for a group of sensors associated with a series of procedural steps in the surgical training procedure. Thus, the correspondence between the sensors 734 and the emitters 736 may not be one to one.

In the example of FIG. 13, the anatomic simulacra 702 includes emitters 736a-736g, with each of the emitters 736a-736g associated with one of the sensors 734a-734g. In the example of FIG. 13, the emitters 736a-736g may comprise light emitting elements, or light emitting diodes, which may illuminate in various colors. For example, the emitters 736a-736g may illuminate in a “green” color for a successful performance of the surgical training procedure at the observed portion of the anatomic simulacra 702; a “yellow” color to indicate caution should be used; or a “red” color to indicate that the performance of the surgical training procedure at that observed portion of the anatomic simulacra 702 was unsuccessful. As a further example, the emitters 736a-736g may emit a first color to signify a first condition and may emit a second color to signify a second condition. For example, the first condition may be a predefined torque before a further fracture of the anatomic simulacra 702, and the first color may be a “yellow” or other warning color to signify when the predefined torque has been reached. The second condition may indicate the further fracture occurred and the second color may be a “red” or other danger warning color. Alternatively, the second condition may indicate a successful outcome, and the second color may be a “green” or other safe to proceed color. In the example of FIG. 13, the emitters 736a-736g are coupled to the synthetic radius 708 so as to be spaced a distance apart from the characteristic 706 and the performance of the surgical training procedure.

With reference to FIG. 14, the emitters 736 may be in communication with the controller 728 over a suitable communication architecture, which enables the transfer of data, power, etc. In the example of the emitters 736 being in wired communication with the controller 728, the wire may also be embedded within the anatomic simulacra 702.

The communication system 726 may be coupled to the anatomic simulacra 702. The communication system 726 may be in communication with the controller 728 and may transmit data from the controller 728 to the personal electronic device 104, 404 or a remote system 730, for example. In an example, the communication system 726 may comprise a Bluetooth low energy (BLE) transmitter or transceiver, a near field communication (NFC) transmitter or transceiver, a radio frequency (RF) radio transmitter or transceiver, a far field communication transmitter or transceiver, a wireless communication system configured to communicate via a wireless local area network (WLAN) using IEEE 802.11 standards or by using cellular data communication, a Bluetooth transmitter or transceiver, etc. Generally, the controller 728 may communicate data regarding the anatomic simulacra 702 to an external device, such as the personal electronic device 104, 404, the remote system 730, the computing devices 25, the computers 37, 38 and/or the robot 27.

The remote system 730 may include, but is not limited to, at least one of a remote electronic device, a remote server, the surgical suite 20, the robot 27, the computing device 25, the computers 37, 38, etc. In the example of the remote system 730 including the remote electronic device, the remote electronic device may be in communication with the anatomic simulacra 702 to transmit and receive data from the anatomic simulacra 702. For example, the anatomic simulacra 702 may transmit data, such as identification information regarding the anatomic simulacra 702, a usage of the anatomic simulacra 702, etc. The remote electronic device may comprise any suitable electronic device, including, but not limited to, a computer, a tablet, a cellular phone, etc. It should be noted that while the remote electronic device may be described herein as comprising a single remote device, the remote electronic device may also comprise a network of remote devices, which may be in communication with the anatomic simulacra 702 during at least a portion of the surgical training procedure.

In the example of the remote system 730 including a remote server, the remote server may be in communication with the anatomic simulacra 702 to transmit and receive data from the anatomic simulacra 702. For example, the anatomic simulacra 702 may transmit identification information regarding the anatomic simulacra 702, a usage of the anatomic simulacra 702, etc. to the remote server for processing and analysis. The remote system 730 may process the data regarding the anatomic simulacra 702 and the usage of the anatomic simulacra 702 to determine failure rates, outcomes, life of the anatomic simulacra 702, etc.

The controller 728 may include at least one processor 740 and a computer-readable storage device or media 742. The processor 740 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 728, a semiconductor-based microprocessor (in the form of a microchip or chip set), any combination thereof, or generally any device for executing instructions. The computer readable storage device or media 742 may include volatile and nonvolatile storage in read-only memory (ROM), random-access memory (RAM), and keep-alive memory (KAM), for example. KAM is a persistent or non-volatile memory that may be used to store various operating variables while the processor 740 is powered down. The computer-readable storage device or media 742 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the communication system 726 in controlling features of the anatomic simulacra 702. In various examples, the controller 728 may be configured to implement instructions of a specimen control system 800 as described in detail below.

In various examples, the controller 728 may be configured to implement instructions to receive sensor signals from the sensor system 722, and to output one or more control signals to the feedback system 724 based on the received sensor signals. In addition, the controller 728 may be optionally configured to implement instructions to transmit data regarding the anatomic simulacra 702 to the personal electronic device 104, 404, the remote system 730, the computing devices 25, the computers 37, 38 and/or the robot 27 via the communication system 726.

As shown in more detail with regard to FIG. 15 and with continued reference to FIGS. 13 and 14, a dataflow diagram illustrates various examples of the specimen control system 800, which may be embedded within the controller 728. Various examples of the specimen control system 800 according to the present disclosure can include any number of sub-modules embedded within the controller 728. As can be appreciated, the sub-modules shown in FIG. 15 can be combined and/or further partitioned to similarly control the anatomic simulacra 702. Inputs to the specimen control system 800 may be received from the sensor system 722 (FIG. 14), the personal electronic device 104, 404 (FIG. 14), received from other control modules (not shown) associated with the anatomic simulacra 702, received from the surgical suite 20 (FIG. 1A) and/or determined/modeled by other sub-modules (not shown) within the controller 728. In various examples, the specimen control system 800 may include an emitter datastore 810, a table(s) datastore 812, a specimen monitor module 814, a specimen and usage datastore 816, and a device communication control module 818.

The emitter datastore 810 may store emitter identification (ID) data 820. The emitter datastore 810 may store one or more tables (e.g., lookup tables) that indicate the respective one of the emitters 736 that corresponds with a particular one of the sensors 734. As discussed, each one of the sensors 734 may be associated with each one of the emitters 736 so that sensor signals generated by the respective sensor 734 may be provided as feedback by the associated one of the emitters 736. In various examples, the tables may be defined by one or more indexes. The emitter ID data 820 provided by at least one of the tables may indicate the emitter 736 associated with the sensor 734 from which sensor data 822 is received. As an example, one or more tables can be indexed by various parameters such as, but not limited to, the sensors 734, to provide the emitter ID data 820. The one or more tables stored by the emitter datastore 810 may comprise predetermined or predefined, factory set values.

The table(s) datastore 812 may store emitter output data 824. The table(s) datastore 812 may store one or more tables (e.g., lookup tables) that indicate an output for the emitters 736 based on the sensor signals received by the respective one of the sensors 734. For example, the output for the emitters 736 may be based on a value or a range of values contained within the sensor signals. In one example, the table(s) datastore 812 stores output control signals for the emitters 736, which are predefined and factory set based on the sensor signals from the respective sensor 734. For example, the table(s) datastore 812 may store control signals to illuminate the emitter 736 at a particular color based on the sensor signals when the emitter is a light emitting element. As a further example, the table(s) datastore 812 may store control signals to cause the emitter 736 to announce a particular sound or phrase based on the sensor signals when the emitter 736 is an audio emitter. The table(s) datastore 812 may also store control signals to cause the emitter 736 to vibrate in a particular pattern based on the sensor signals when the emitter 736 is a haptic emitter. In various examples, the tables may be defined by one or more indexes. The emitter output data 824 provided by at least one of the tables may include control signals for the emitter 736 based on the value of the sensor signals received from the associated sensor 734. As an example, one or more tables can be indexed by various parameters such as, but not limited to, the sensor data 822, to provide the emitter output data 824.

The specimen monitor module 814 may receive as input the sensor data 822. The sensor data 822 may comprise the sensor signals from one or more of the sensors 734. The specimen monitor module 814 may process the sensor data 822 and may determine which one of the sensors 734 generated the sensor data 822. The specimen monitor module 814 may query the emitter datastore 810 and retrieve the emitter ID data 820 that corresponds with the identified sensor 734 based on the sensor data 822. The specimen monitor module 814 may also process the sensor data 822 and determine a value for the sensor signals. For example, in the example of one of the sensors 734 as a tension meter, the specimen monitor module 814 may process the sensor data 822 and determine an amount of torque, a torque value or a value observed by the sensor 734. The specimen monitor module 814 may query the table(s) datastore 812 and retrieve the emitter output data 824 that corresponds to the amount of torque or value in the sensor data 822. Based on the emitter ID data 820 and the emitter output data 824, the specimen monitor module 814 may output emitter control data 826. The emitter control data 826 may comprise one or more control signals for the emitter 736 identified in the emitter ID data 820 to produce feedback for the trainee that corresponds to the sensor data 822.

The specimen monitor module 814 may also associate the sensor data 822 with the emitter ID data 820 and the emitter output data 824, and store this as usage data 828 in the usage datastore 816. The usage data 828 may comprise the sensor data 822 and the control signals output to the associated emitter 736 based on the sensor data 822. Stated another way, the usage data 828 may comprise data of the usage of the anatomic simulacra 702 as observed by the sensor system 722 and may include data of feedback provided by the feedback system 724 during the usage of the anatomic simulacra 702. The usage data 828 may also include a timestamp, based on a timer associated with other modules of the controller 728, which may indicate a time the sensor data 822 was received by the specimen monitor module 814.

The specimen and usage datastore 816 may store data associated with the anatomic simulacra 702. For example, the specimen and usage datastore 816 may store specimen identification data 830 and specimen usage data 832. The specimen identification data 830 may provide information regarding the anatomic simulacra 702 including, but not limited to the type of anatomic simulacra 702, the characteristic 706 associated with the anatomic simulacra 702, a model number associated with the anatomic simulacra 702, the sensor system 722 associated with the anatomic simulacra 702 (which may also include a location of the sensors 734 associated with the anatomic simulacra 702), the feedback system 724 associated with the anatomic simulacra 702, etc. The specimen identification data 830 may be predefined, factory set data. The specimen usage data 832 may comprise compiled data or all of the usage data 828 that is populated by the specimen monitor module 814 during the usage of the anatomic simulacra 702. Thus, generally, the specimen usage data 832 may comprise data regarding the usage of the anatomic simulacra 702 over a predetermined period of time of the anatomic simulacra 702.

The communication control module 818 may receive as input request data 834. The request data 834 may comprise a request for data regarding the anatomic simulacra 702, which may be received from the personal electronic device 104, 404, from the remote system 730, the computing devices 25, the computers 37, 38 and/or the robot 27. Based on the request data 834, the communication control module 818 may query the specimen and usage datastore 816 and retrieve the specimen identification data 830 and the specimen usage data 832. The communication control module 818 may output the specimen identification data 830 and the specimen usage data 832 as specimen data 836 for the personal electronic device 104, 404, the remote system 730, the computing devices 25, the computers 37, 38 and/or the robot 27.

In certain instances, the communication control module 818 may query the specimen and usage datastore 816 and retrieve the specimen identification data 830 and the specimen usage data 832 substantially in real-time during the performance of the surgical training procedure. The communication control module 818 may output the specimen identification data 830 and the specimen usage data 832 as specimen data 836 for the personal electronic device 104, 404, the remote system 730, the computing devices 25, the computers 37, 38 and/or the robot 27 substantially in real-time during the performance of the surgical training procedure. Based on the receipt of the specimen identification data 830 and the specimen usage data 832, the personal electronic device 104, 404, the remote system 730, the computing devices 25 and/or the computers 37, 38 may render a graphical user interface for display on a display, such as one of the displays 34 that includes the information regarding the anatomic simulacra 702, which may be superimposed with the sensor data 822 and the control signals output to the associated emitter 736 based on the sensor data 822. This may permit the trainee (and optionally, other medical staff) to monitor the performance of the surgical training procedure substantially in real-time using the surgical suite 20.

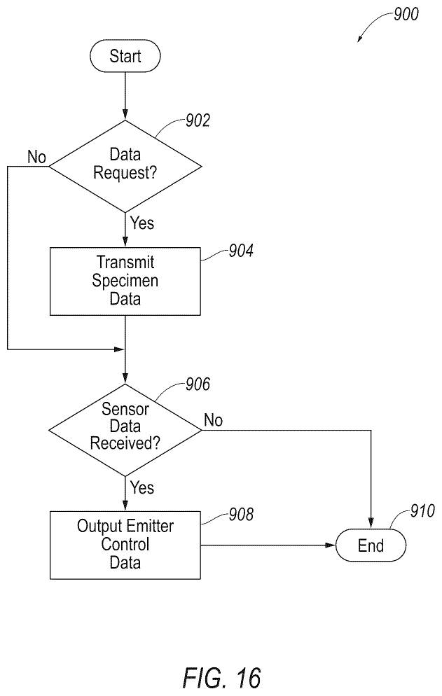

Referring now to FIG. 16, and with continued reference to FIGS. 13-15, a flowchart illustrates a method 900 that can be performed by the specimen control system 800 of FIG. 15 in accordance with the present disclosure. In one example, the method 900 is performed by the processor 740 of the controller 728 of the anatomic simulacra 702. As can be appreciated in light of the disclosure, the order of operation within the method 900 is not limited to the sequential execution as illustrated in FIG. 16, but may be performed in one or more varying orders as applicable and in accordance with the present disclosure. In various examples, the method 900 may run based on receipt of the request data 834 and/or receipt of the sensor data 822.

At 902, the method may determine whether the request data 834 has been received by the communication control module 818. If true, the method may proceed to 904. Otherwise, the method may proceed to 906.

At 904, the method may output the specimen data 836, which includes the specimen identification data 830 and the specimen usage data 832 to the personal electronic device 104, 404, the remote system 730, the computing devices 25, the computers 37, 38 and/or the robot 27.

At 906, the method may determine whether sensor signals or the sensor data 822 has been received from one or more of the sensors 734. If true, the method may proceed to 908. Otherwise, the method may end at 910.

At 908, based on the sensor signals or the sensor data 822, the method may process the sensor data 822 and query the emitter datastore 810 to retrieve the emitter(s) 736 associated with the sensor data 822. The method may process the sensor data 822 and query the table(s) datastore 812 to retrieve the emitter output data 824 associated with the value in the sensor data 822. The method may output the emitter control data 826, which includes the control signals for the respective emitters 736 based on the sensor signals or sensor data 822. The method may end at 910.

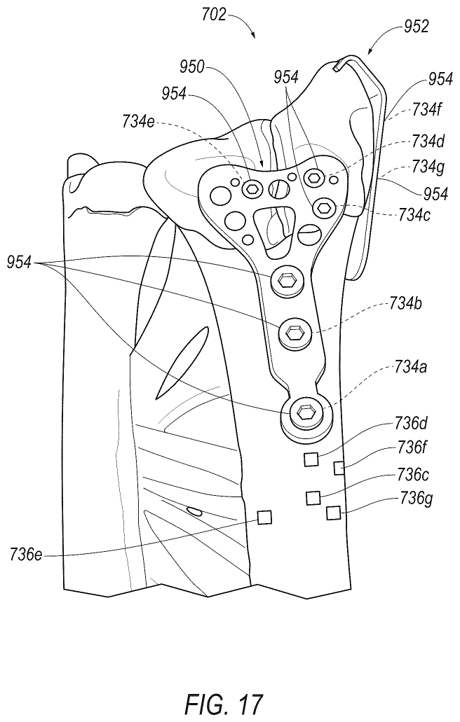

With reference to FIG. 17, a simplified schematic illustration of the anatomic simulacra 702 is shown. In FIG. 17, a first implant 950 and a second implant 952 have been coupled to the anatomic simulacra 702 to repair the characteristic 706, which was a fracture pattern, associated with the anatomic simulacra 702. In this example, the first implant 950 and the second implant 952 are coupled to the anatomic simulacra 702 with a plurality of implants 954, such as biocompatible mechanical fasteners. As shown, the sensors 734a-734g are coupled to or embedded within the anatomic simulacra 702 so as to be positioned proximate, adjacent to or beneath the implants 950, 952, 954.

Thus, as the trainee couples the implants 950, 952, 954 to the anatomic simulacra 702, the sensors 734a-734g may observe the forces applied by the trainee and generate sensor signals based thereon. In the example of the sensors 734a-734g comprising tension meters, as the trainee applies a torque to each of the implants 954, the corresponding emitters 736a-736g may illuminate based on the value of the torque observed by the sensors 734a-734g as controlled by the controller 728. This provides feedback to the trainee during the surgical training procedure, which permits the trainee to alter or adjust the torque applied, for example, during the surgical training procedure. This also allows the trainee to learn the desired amount of torque to apply to each of the implants 954 to secure the first implant 950 and the second implant 952 to the anatomic simulacra 702. In addition, in the instance that the first implant 950 may be loosened as the second implant 952 is coupled to the anatomic simulacra 702, the sensors 734a-734e may generate sensor signals that are indicative of this reduced torque, which may be received by the controller 728, and the output of the emitters 736a-736e may be adjusted by the controller 728 based on the sensor signals to alert the trainee substantially in real-time to the change in the applied torque.

Thus, the system 100, 400, 700 may enable a trainee to acquire information regarding the anatomic simulacra 102, 402, 702, which may be relevant for a surgical training procedure involving the anatomic simulacra 102, 402, 702. In the example of the system 100, the trainee may also obtain the touch points and feedback, such as the sensor data, which may indicate the force, pressure, torque, etc. applied during the surgical training procedure. This may provide feedback to the trainee, which may provide the trainee with an opportunity to adapt a subsequent performance of this surgical training procedure based on this feedback. In addition, by displaying a three-dimensional model of the anatomic simulacra 102, 402 on the display 162, 34, the trainee may visualize the features associated with the anatomic simulacra 102, 402, such as the characteristic 106, 406. In certain instances, the human-machine interface 150 and/or the computers 37, 38 may also include features to interact with the three-dimensional model, including, but not limited to, zoom, cross-section tools, surgical planning tools, etc.

In the example of the system 700, the trainee may also obtain the feedback from the emitters 736 in substantially real-time based on the sensor data from the sensors 734, which may indicate the force, pressure, torque, etc. applied at the particular procedural step of the surgical training procedure. By providing the feedback system 724, the trainee may learn in substantially real-time an amount of force, pressure, torque, etc. to apply to a particular implant at a particular point in the surgical training procedure. This may be advantageous, for example, in the instance where the application of a particular force over a threshold may result in a subsequent fracture. In addition, by storing the usage of the anatomic simulacra 702 in the specimen and usage datastore 816, the system 700 enables the data associated with the anatomic simulacra 702 and the usage of the anatomic simulacra 702 to be analyzed to determine outcomes, failure rates, coordinate improvements to the surgical training procedure, etc.

It should be understood that while the specimen system 116 is described and illustrated herein as being embedded within a portion of a synthetic anatomy associated with the anatomic simulacra 102 and the specimen system 422 is described and illustrated herein as being embedded within a portion of a mounting structure for the anatomic simulacra 402, generally, the specimen system 116, 422 may be embedded in any portion of the anatomic simulacra 102, 402, and thus, the examples contained herein are not intended to be limiting.

In addition, while the anatomic simulacra 102, 402, 702 are described and illustrated herein as including the identification tag 114, 420, 714, the respective anatomic simulacra 102, 402, 702 may also include a code, such as a quick reference (QR) code, which may be coupled to the anatomic simulacra 102, 402, 702 via a sticker and/or included on the identification tag 114, 420, 714. The code may be scannable by the personal electronic device 104, 404 to provide access to the information and/or digital content such as pre-recorded videos, papers, etc. regarding the anatomic simulacra 102, 402, 702 and/or a surgical training procedure(s) associated with the anatomic simulacra 102, 402, 702 at an external source such as a website. Thus, in some examples, the communication system associated with the anatomic simulacra 102, 402, 702 may comprise the code.

In addition, the specimen system 116, 422, 716 of the anatomic simulacra 102, 402, 702 may also include a radio frequency (RF) identification tag, which may be coupled to the anatomic simulacra 102, 403, 702 proximate the identification tag 114, 420, 714. The radio frequency (RF) identification tag may be scannable by a radio frequency (RF) identification reader, for example, to provide information regarding the anatomic simulacra 102, 402, 702 to a remote system, such as the remote system 730. This may allow the tracking of the 102, 402, 702 for inventory management, for example. Thus, in some examples, the communication system associated with the anatomic simulacra 102, 402, 702 may also comprise the radio frequency (RF) identification tag.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominantly in the respective nominal axial or radial direction. As used herein, the term “about” denotes within 15% to account for manufacturing tolerances. In addition, the term “substantially” denotes within 15% to account for manufacturing tolerances.

As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

The present disclosure may be described herein in terms of functional and/or logical block components and various processing steps. It should be appreciated that such block components may be realized by any number of hardware, software, and/or firmware components configured to perform the specified functions. For example, the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that the present disclosure may be practiced in conjunction with any number of systems, and that the systems described herein are merely examples.

For the sake of brevity, conventional techniques related to signal processing, data transmission, signaling, control, machine learning models, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in the present disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An anatomic simulacra, comprising:
a communication system coupled to the anatomic simulacra that is configured to communicate data regarding the anatomic simulacra to an external device.

2. The anatomic simulacra of claim 1, wherein the anatomic simulacra is polymer-based and corresponds to at least a portion of a human or animal anatomy, and the communication system is embedded within a portion of the anatomic simulacra.

3. The anatomic simulacra of claim 1, wherein the anatomic simulacra further comprises at least one sensor coupled to the anatomic simulacra, and the at least one sensor is configured to observe a portion of the anatomic simulacra and to generate sensor signals based thereon.

4. The anatomic simulacra of claim 3, wherein the anatomic simulacra further comprises a controller, and the controller is configured to receive the sensor signals, and to command the communication system to communicate the sensor signals to the external device.

5. The anatomic simulacra of claim 4, wherein the anatomic simulacra further comprises at least one emitter associated with the at least one sensor and the controller is configured to output one or more control signals to the at least one emitter based on the sensor signals.

6. The anatomic simulacra of claim 5, wherein the at least one emitter is selected from the group comprising a light emitting element, an audio emitter, a haptic emitter, and combinations thereof.

7. The anatomic simulacra of claim 1, wherein the anatomic simulacra further comprises an identification tag, and the communication system is coupled to the anatomic simulacra so as to be proximate the identification tag.

8. The anatomic simulacra of claim 1, wherein the communication system comprises a scannable code or a radio frequency identification tag.

9. The anatomic simulacra of claim 1, wherein the external device is configured to display the data regarding the anatomic simulacra on a display associated with the external device.

10. A system for surgical training, comprising:
a polymer-based anatomic simulacra that corresponds to a part of an anatomy; and
a communication system coupled to the anatomic simulacra that is configured to communicate data regarding the anatomic simulacra to an external device.

11. The system of claim 10, further comprising the external device, wherein the external device is at least one of a personal electronic device, a computing device associated with a surgical system and a remote system, and the external device is configured to display the data regarding the anatomic simulacra on a display associated with the external device.

12. The system of claims 10, wherein the anatomic simulacra is polymer-based and corresponds to at least a portion of a human or animal anatomy, and the communication system is embedded within a portion of the anatomic simulacra.

13. The system of claim 10, wherein the anatomic simulacra further comprises at least one sensor coupled to the anatomic simulacra, and the at least one sensor is configured to observe a portion of the anatomic simulacra and to generate sensor signals based thereon.

14. The system of claim 13, wherein the anatomic simulacra further comprises a controller, and the controller is configured to receive the sensor signals and to command the communication system to communicate the sensor signals to the external device.

15. The system of claim 14, wherein the anatomic simulacra further comprises at least one emitter associated with the at least one sensor and the controller is configured to output one or more control signals to the at least one emitter based on the sensor signals.

16. A method for surgical training, comprising:
providing a polymer-based anatomic simulacra that corresponds to a part of an anatomy with a system coupled to the anatomic simulacra; and
communicating, by a processor of a controller of the system, data regarding the anatomic simulacra to an external device.

17. The method of claim 16, further comprising:
receiving, by the processor, a request for data from the external device and the communicating is based on the request.

18. The method of claim 16, wherein the external device is at least one of a personal electronic device, a computing device associated with a surgical system, a remote system and a robot.

19. The method of claim 16, wherein the anatomic simulacra further comprises at least one sensor coupled to the anatomic simulacra configured to observe a portion of the anatomic simulacra and to generate sensor signals based on the observation, and the method further comprises:
communicating, by the processor, the sensor signals to the external device.

20. The method of claim 19, further comprising:
displaying, on a display associated with the external device, the sensor signals and the data regarding the anatomic simulacra.
